(19) United States
(12) Patent Application Publication
(10) Pub. No.: US 2023/0145740 A1
(43) Pub. Date: May 11, 2023

(54) OPTICAL FILTER

(71) Applicant: AGC Inc., Tokyo (JP)

(72) Inventors: Kazuhiko SHIONO, Fukushima (JP); Takuro SHIMADA, Fukushima (JP); Yuichiro ORITA, Fukushima (JP)

(73) Assignee: AGC Inc., Tokyo (JP)

(21) Appl. No.: 18/155,319

(22) Filed: Jan. 17, 2023

Related U.S. Application Data
(63) Continuation of application No. PCT/JP2021/026882, filed on Jul. 16, 2021.

(30) Foreign Application Priority Data
Jul. 27, 2020 (JP) 2020-126700

(51) Int. Cl. G02B 5/28; C08K 5/3462; C08K 5/3415; C08K 5/45; C08K 5/3465; C08K 5/3475; C08K 5/3417; C09B 67/20; C09B 67/22

(52) U.S. Cl. CPC G02B 5/283; C08K 5/3462; C08K 5/3415; C08K 5/45; C08K 5/3465; C08K 5/3475; C08K 5/3417; C09B 67/0063; C09B 67/0033; G02B 5/285; C08K 2201/014; G02B 5/281

(57) ABSTRACT

The present invention relates to an optical filter including: a substrate; and a dielectric multilayer film laid on or above at least one major surface of the substrate, as an outermost layer, in which: the substrate includes a resin film containing a dye (U) having a maximum absorption wavelength in a range of 360 to 395 nm in dichloromethane, a dye (A) having a maximum absorption wavelength in a range of 600 to 800 nm in dichloromethane, and a resin; and the optical filter satisfies spectral characteristics (i-1) to (i-5).

### CROSS-REFERENCE TO RELATED APPLICATIONS

This is a bypass continuation of International Patent Application No. PCT/JP2021/026882, filed on Jul. 16, 2021, which claims priority to Japanese Patent Application No. 2020-126700, filed on Jul. 27, 2020. The contents of these applications are hereby incorporated by reference in their entireties.

### TECHNICAL FIELD

The present invention relates to an optical filter that transmits light in a visible wavelength range and interrupts light in an ultraviolet wavelength range and a near-infrared wavelength range.

### BACKGROUND ART

To reproduce colors satisfactorily and obtain a clear image, an optical filter that transmits light in a visible range (hereinafter also referred to as “visible light”) and that interrupts light in an ultraviolet wavelength range (hereinafter also referred to as “ultraviolet light” or “UV light”) and light in a near-infrared wavelength range (hereinafter also referred to as “near-infrared light” or “NIR light”) is used in imaging apparatus provided with a solid-state imaging device.

Examples of such an optical filter include various types of optical filters such as a reflection optical filter in which dielectric thin-films having different refractive indices are laid alternately (to form a dielectric multilayer film) on one or both surfaces of a transparent substrate and that thereby reflects light to be interrupted utilizing light interference. In an optical filter including such a dielectric multilayer film, the optical thickness of the dielectric multilayer film varies depending on the light incident angle. The optical filter therefore has problems such as an incident angle-dependent variation of a spectral transmittance curve, light leakage in which ultraviolet light that should be high in reflectance is increased in transmittance at a large incident angle, and occurrence of noise due to ultraviolet light reflected by the dielectric multilayer film. In the case where such a filter is used, the spectral sensitivity of a solid-state imaging device may be affected by the incident angle. An optical filter was therefore desired that can interrupt ultraviolet light with causing almost no influence on the visible light transmittance and with no dependence on the incident angle.

In this connection, Patent documents 1 to 4 disclose optical filters whose dependence on the incident angle of light in a wavelength range of 370 to 425 nm is low and that has both a UV cutting ability and an NIR cutting ability as a result of a combination of a dielectric multilayer film and an absorption layer that contains a UV absorbing dye and an NIR absorbing dye in a transparent resin.

### CITATION LIST

### Patent Literature

Patent document 1: JP-A-2019-16649

Patent document 2: Japanese Patent No. 6,504,176

Patent document 3: Japanese Patent No. 6,020,740

Patent document 4: Japanese Patent No. 6,256,335

### SUMMARY OF INVENTION

### Technical Problem

However, the optical filters disclosed in Patent documents 1-4 have room for improvement in the transparency of visible light, in particular, blue light, and the ultraviolet light shieldability at large incident angles.

An object of the present invention is therefore to provide an optical filter that exhibits high visible light transparency and high near-infrared light and ultraviolet light shieldability, in particular, an optical filter that exhibits high blue light transparency and that is suppressed in the reduction of ultraviolet light shieldability at large incident angles.

### Solution to Problem

The present invention provides optical filters having the following configurations:

[1] An optical filter including:

a substrate; and

a dielectric multilayer film laid on or above at least one major surface of the substrate, as an outermost layer, in which:

the substrate includes a resin film containing a dye (U) having a maximum absorption wavelength in a range of 360 to 395 nm in dichloromethane, a dye (A) having a maximum absorption wavelength in a range of 600 to 800 nm in dichloromethane, and a resin; and

the optical filter satisfies all of the following spectral characteristics (i-1) to (i-5):

(i-1) an average transmittance T₄₄₀-480 of a spectral transmittance curve in a wavelength range of 440 to 480 nm is 86% or more;

(i-2) an absolute value of a difference between UV10_{(0deg)} and UV10_{(50deg)} is 3 nm or less, an absolute value of a difference between UV20_{(0deg)} and UV20_{(50deg)} is 4 nm or less, and an absolute value of a difference between UV50_{(0deg)} and uV50_{(50deg)} is 4 nm or less, where UV10_{(0deg)}, UV20_{(0deg)}, and UV50_{(0deg)} represent wavelengths at which transmittances are 10%, 20%, and 50%, respectively, at an incident angle of 0° in a wavelength range of 350 to 450 nm, and UV10_{(50deg)}, UV20_{(50deg)}, and UV50_{(50deg)} represent wavelengths at which transmittances are 10%, 20%, and 50%, respectively, at an incident angle of 50° in a wavelength range of 350 to 450 nm;

(i-3) an average transmittance T₄₀₀₋₄₄₀ of a spectral transmittance curve in a wavelength range of 400 to 440 nm is 40% or more;

(i-4) an average transmittance T_{370-400(0deg)} of a spectral transmittance curve at an incident angle of 0° in a wavelength range of 370 to 400 nm is 1% or less; and

(i-5) an average transmittance T_{370-400(50deg)} of a spectral transmittance curve at an incident angle of 50° in a wavelength range of 370 to 400 nm is 0.5% or less.

### Advantageous Effects of Invention

The present invention can provide an optical filter that exhibits high visible light transparency and high near-infrared light and ultraviolet light shieldability, in particular, an optical filter that exhibits high blue light transparency and that is suppressed in the reduction of ultraviolet light shieldability at large incident angles.

### BRIEF DESCRIPTION OF DRAWINGS

FIG. 1 is a sectional view schematically illustrating an optical filter according to one embodiment.

FIG. 2 is a sectional view schematically illustrating an optical filter according to another embodiment.

FIG. 3 is a sectional view schematically illustrating an optical filter according to another embodiment.

FIG. 4 is a sectional view schematically illustrating an optical filter according to another embodiment.

FIG. 5 is a graph showing spectral transmittance curves of the optical filter of Example 2-14.

FIG. 6 is a graph showing spectral transmittance curves of the optical filter of Example 2-15.

### DESCRIPTION OF EMBODIMENT

An embodiment of the present invention will be described below. In this specification, a near-infrared absorbing dye and an ultraviolet light absorbing dye may be abbreviated as “NIR dye” and “UV dye,” respectively. In this specification, a compound represented by formula (I) will be referred to as a “compound (I)” and similar notations will be used for compounds represented by other formulae. A dye made of a compound (I) will also be referred to as a “dye (I)” and similar notations will be used for other dyes. Furthermore, a group represented by formula (1) will also be referred to as a “group (I)” and similar notations will be used for groups represented by other formulae.

In this specification, the “internal transmittance” means transmittance obtained by subtracting influence of interface reflection from measured transmittance and is represented by an equation (measured transmittance)/(100-reflectance).

In this specification, as for a transmittance of a substrate and a transmittance of a resin film including a case that a dye is contained in a resin, an “internal transmittance” is meant in all cases including a case that only a word “transmittance” is used. On the other hand, a transmittance that is measured by dissolving a dye in a solvent such as dichloromethane and a transmittance of an optical filter having a dielectric multilayer film are each measured transmittance.

In this specification, for example, the expression “the transmittance is 90% or more in a particular wavelength range” means that the transmittance is not less than 90% in the whole of that wavelength range, that is, the smallest transmittance in that wavelength range is 90% or more. Likewise, for example, the expression “the transmittance is 1% or less in a particular wavelength range” means that the transmittance is not more than 1% in the whole of that wavelength range, that is, the highest transmittance in that wavelength range is 1% or less. The same is true of the internal transmittance. An average transmittance or an average internal transmittance in a particular wavelength range is an arithmetic average of transmittance values or internal transmittance values every 1 nm wavelength in that wavelength range.

In this specification, the symbol “-” or the word “to” used to indicate a numerical value range is used to include numerical values written before and after it as a upper limit value and a lower limit value, respectively.

<Optical filter>

An optical filter according to one embodiment of the present invention (hereinafter also referred to as “the present filter”) includes a substrate and a dielectric multilayer film laid on or above at least one major surface of the substrate, as an outermost layer and the optical filter satisfies particular spectral characteristics described later. The substrate includes a resin film that contains a dye (U) having a maximum absorption wavelength in a range of 360 to 395 nm in dichloromethane, a dye (A) having a maximum absorption wavelength in a range of 600 to 800 nm in dichloromethane, and a resin.

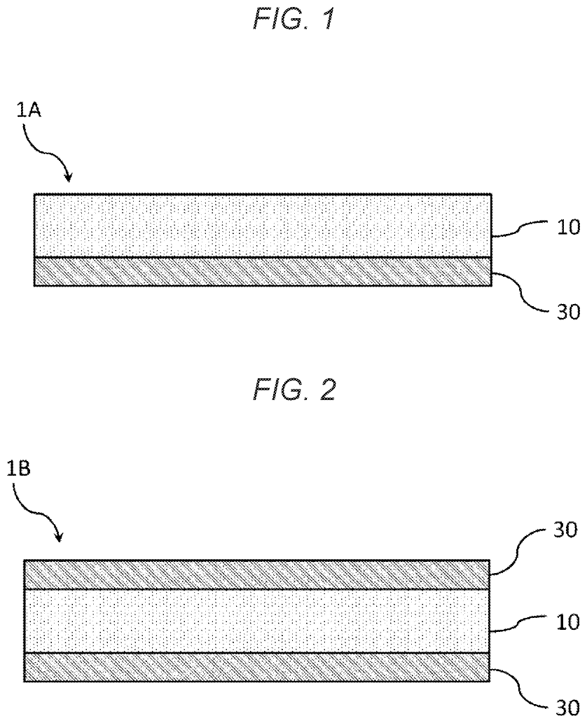

Examples of configurations of the present filter will be described with reference to the drawings. FIGS. 1 to 4 are schematic sectional views each illustrating an example of an optical filter according to one embodiment.

An optical filter lA illustrated in FIG. 1 is an example in which a dielectric multilayer film 30 is formed on one major surface of a substrate 10. The expression “to have a particular layer on or above a major surface of a substrate” is not limited to a case that the layer is in contact with the major surface of the substrate but includes a case that another layer is provided between the substrate and the layer.

FIG. 2 illustrates another example in which an optical filter 1B includes a dielectric multilayer film 30 on both major surfaces of a substrate 10.

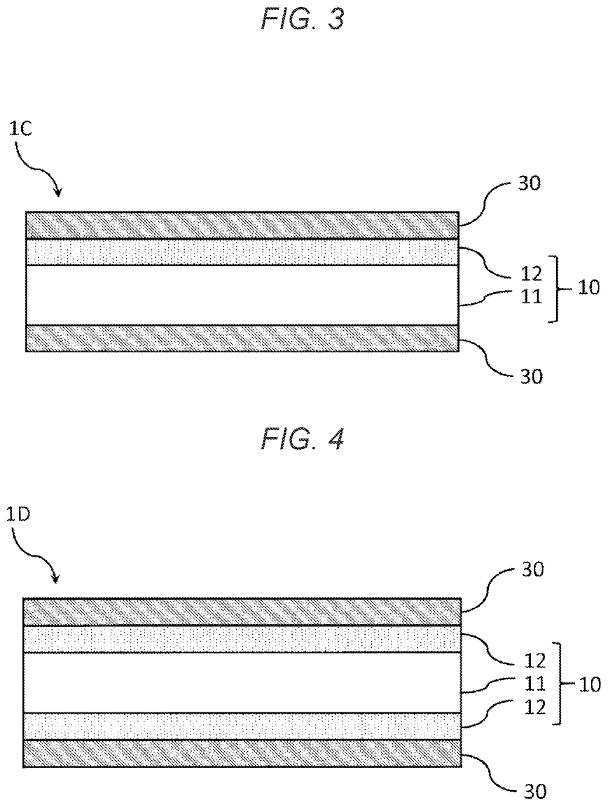

FIG. 3 illustrates another example in which a substrate 10 of an optical filter 1C includes a support body 11 and a resin film 12 that is laid on one major surface of the support body 11. Furthermore, in the optical filter 1C, a dielectric multilayer film 30 is formed on the resin film 12 and on another major surface, on which the resin film 12 is not laid, of the support body 11.

FIG. 4 illustrates another example in which a substrate 10 of an optical filter 1D includes a support body 11 and resin films 12 that are laid on both major surfaces of the support body 11. Furthermore, in the optical filter 1D, dielectric multilayer films 30 are formed on the respective resin films 12.

The substrate of the optical filter according to the present invention includes a dye (U) having a maximum absorption wavelength in a range of 360 to 395 nm in dichloromethane, a dye (A) having a maximum absorption wavelength in a range of 600 to 800 nm in dichloromethane, and a resin. The dye (U) is a UV dye and the dye (A) is an NIR dye. In the case where the substrate includes dyes that absorb ultraviolet light or near-infrared light, deterioration of the spectral characteristics of the dielectric multilayer film at large incident angles, such as light leakage in an ultraviolet range or a near-infrared range and generation of noise etc., can be suppressed by the absorption property of the substrate. The individual dyes and the resin will be described later.

The optical filter according to the present invention satisfies all of the following spectral characteristics (i-1) to (i-5):

(i-1) an average transmittance T₄₄₀-480 of a spectral transmittance curve in a wavelength range of 440 to 480 nm is 86% or more;

(i-2) an absolute value of a difference between UV10_{(0deg)} and UV10_{(50deg)} is 3 nm or less, an absolute value of a difference between UV20_{(0deg)} and UV20_{(50deg)} is 4 nm or less, and an absolute value of a difference between UV50_{(0deg)} and UV50_{(50deg)} is 4 nm or less, where UV10_{(0deg)}, UV20_{(0deg)}, and UV50_{(0deg)} represent wavelengths at which transmittances are 10%, 20%, and 50%, respectively, at an incident angle of 0° in a wavelength range of 350 to 450 nm, and UV10_{(50deg)}, UV20_{(50deg)}, and UV50_{(50deg)} represent wavelengths at which transmittances are 10%, 20%, and 50%, respectively, at an incident angle of 50° in a wavelength range of 350 to 450 nm;

(i-3) an average transmittance T₄₀₀₋₄₄₀ of a spectral transmittance curve in a wavelength range of 400 to 440 nm is 40% or more;

(i-4) an average transmittance T_{370-400(0deg)} of a spectral transmittance curve at an incident angle of 0° in a wavelength range of 370 to 400 nm is 1% or less; and

(i-5) an average transmittance T_{370-400(50deg)} of a spectral transmittance curve at an incident angle of 50° in a wavelength range of 370 to 400 nm is 0.5% or less.

The present optical filter that satisfies all of the spectral characteristics (i-1) to (i-5) is an optical filter in which the ultraviolet light shieldability is high, in particular, the reduction of ultraviolet light shieldability at large incident angles is suppressed while the visible light transparency, particularly the blue light transparency, is kept high.

The satisfaction of the spectral characteristic (i-1) means that the transparency in a visible range is high. In the spectral characteristic (i-1), it is preferable that T₄₄₀₋₄₈₀ be 87% or more, even preferably 89% or more.

The satisfaction of the spectral characteristic (i-2) means that the shift is small even at large incident angles in a wavelength range of 350 to 450 nm (i.e., in and around a UV absorption start band) and hence the color reproducibility is high. In the spectral characteristic (i-2), the absolute value of the difference between UV10_{(0deg)} and UV10_{(50deg)} is preferably 2.5 nm or less, the absolute value of the difference between UV20_{(0deg)} and UV20_{(50deg)} is preferably 3 nm or less, and the absolute value of the difference between UV50_{(0deg)} and UV50_{(50deg)} is preferably 3 nm or less.

The satisfaction of the spectral characteristic (i-3) means that the blue light transmittance is high in a wavelength range of 400 to 440 nm (i.e., in a wavelength range that is a little longer than the UV absorption start band). In the spectral characteristic (i-3), it is preferable that T₄₀₀₋₄₄₀ be 45% or more, even preferably 50% or more.

The satisfaction of the spectral characteristic (i-4) means that the light shieldability is high in a wavelength range of 370 to 470 nm (UV absorption band). In the spectral characteristic (i-4), it is preferable that T_{370-400(0deg)} be 0.5% or less.

The satisfaction of the spectral characteristic (i-5) means that light leakage is not prone to occur, that is, the light shieldability is high, even at large incident angles in a wavelength range of 370 to 400 nm (UV absorption band). In the spectral characteristic (i-5), it is preferable that T_{370-400(50deg)} be 0.1% or less.

It is preferable that the optical filter according to the present invention further satisfy the following spectral characteristic (i-6):

(i-6) an absolute value of a difference between UV10_{(0deg)} and UV70_{(0deg)} is 16 nm or less, where UV10_{(0deg)} and UV70_{(0deg)} represent wavelengths at which transmittances are 10% and 70%, respectively, at an incident angle of 0° in a wavelength range of 350 to 450 nm.

The satisfaction of the spectral characteristic (i-6) means that the slope of a spectral transmittance curve is steep in a wavelength range of 350 to 450 nm (i.e., in and around a UV absorption start band). It is even preferable that the absolute value mentioned in the spectral characteristic (i-6) be 14 nm or less, particularly preferably 13 nm or less.

The substrate and the dielectric multilayer film will be described below. For example, the present filter is designed so that the substrate has ultraviolet light and near-infrared light absorption ability and the above-mentioned spectral characteristics (i-1) to (i-5) are satisfied by the absorption property of the substrate and the reflection property of the dielectric multilayer film.

<Sub strate>

In the optical filter according to the present invention, the substrate includes the resin film that contains the dye (U), the dye (A) (described later), and the resin.

<UV Dye>

The dye (U) is a UV dye having a maximum absorption wavelength in a range of 360 to 395 nm in dichloromethane. Having this dye, the optical filter can cut ultraviolet light effectively.

It is preferable that the dye (U) have particular spectral characteristics in a resin. Specifically, it is preferable that the dye (U), in a spectral transmittance curve of a coated film formed by coating an alkali glass plate with a solution obtained by dissolving the dye (U) in a resin, satisfy all of the following spectral characteristics (ii-1) to (ii-6). It is preferable that the resin be the same as a resin contained in the substrate.

(ii-1) an average transmittance T₄₀₀-440 in a wavelength range of 400 to 440 nm is 40% or more;

(ii-2) an average transmittance T₃₇₀-400 in a wavelength range of 370 to 400 nm is 5% or less;

(ii-3) a transmittance T₄₀₀ at a wavelength of 400 nm is 7% or less;

(ii-4) a transmittance T₃₉₀ at a wavelength of 390 nm is 5% or less;

(ii-5) a transmittance T₃₈₀ at a wavelength of 380 nm is 5% or less; and

(ii-6) a transmittance T₃₇₀ at a wavelength of 370 nm is 5% or less.

The satisfaction of the optical characteristic (ii-1) means that the blue light transmittance is high in a wavelength range of 400 to 440 nm (i.e., in a wavelength range that is a little longer than the UV absorption start band). It is even preferable that T400-440 of the optical characteristic (ii-1) be 45% or more, particularly preferably 50% or more.

The satisfaction of the optical characteristic (ii-2) means that the light shieldability is high in a wavelength range of 370 to 400 nm (UV absorption band). It is even preferable that T370-400 of the optical characteristic (ii-2) be 3% or less, particularly preferably 2% or less.

In the case where the optical characteristic (ii-3) is satisfied, the transmittance is low at a wavelength of 400 nm which is a UV absorption start wavelength, which means that the light shieldability is high in a wavelength range that is shorter than this wavelength. It is even preferable that the transmittance T₄₀₀ of the optical characteristic (ii-3) be 5% or less, particularly preferably 2% or less.

The satisfaction of the optical characteristics (ii-4) to (ii-6) means that necessary light shieldability can be secured by absorption in a wavelength range of 370 to 390 nm in which light leakage is prone to occur because a dielectric multilayer film cannot interrupt light entering at a large incident angle sufficiently.

It is even preferable that T₃₉₀ of the optical characteristics (ii-4) be 3% or less, particularly preferably 1% or less.

It is even preferable that T₃₈₀ of the optical characteristics (ii-5) be 3% or less, particularly preferably 1% or less.

It is even preferable that T₃₇₀ of the optical characteristics (ii-6) be 3% or less, particularly preferably 1% or less.

It is preferable that the dye (U), in the spectral transmittance curve of the coated film, further satisfy the following spectral characteristic (ii-7):

(ii-7): an average internal transmittance T₄₄₀₋₄₈₀ in a wavelength range of 440 to 480 nm is 79% or more.

The satisfaction of the optical characteristic (ii-7) means that absorption by the dye itself does not cause a loss of transmittance in a visible range. It is even preferable that T₄₄₀₋₄₈₀ of the optical characteristic (ii-7) be 80% or more, particularly preferably 81% or more.

Furthermore, it is preferable that the dye (U) satisfy the following spectral characteristic (iii-1):

(iii-1) an absolute value of a difference between UV10 and UV70 is 25 nm or less, where UV10 and UV70 represent wavelengths at which transmittances are 10% and 70%, respectively, in a wavelength range of 350 to 450 nm in a spectral transmittance curve that is measured by dissolving the dye (U) in dichloromethane so that a transmittance at a maximum absorption wavelength becomes 10%.

The satisfaction of the spectral characteristic (iii-1) means that the slope of the spectral transmittance curve is steep in a wavelength range of 350 to 450 nm (i.e., in and around a UV absorption start band). This makes it possible to transmit necessary blue light more and efficiently interrupt ultraviolet light to be interrupted.

It is even preferable that the absolute value mentioned in the spectral characteristic (iii-1) be 22 nm or less.

One kind of the dye (U) may be used in the substrate singly or two or more kinds of the dye (U) may be used in the substrate in combination. From the viewpoint of enabling more efficient light shielding of ultraviolet light with a small content, it is preferable to use two or more kinds of the dye (U) having different maximum absorption wavelengths in combination. In the case where two or more kinds of the dye (U) are used in combination, it is not necessary that each compound exhibit the properties of the dye (U); it suffices that a mixture exhibits the properties of the dye (U).

It is even preferable to use, as the dye (U), a dye (U1) having a maximum absorption wavelength in a range of 370 to 385 nm in dichloromethane. Furthermore, in the case where the substrate contains the dye (U1), it is preferable that the substrate further contain a dye (U2) having a maximum absorption wavelength in a range of 385 to 405 nm in dichloromethane. It is preferable that the dyes (U1) and (U2) have different maximum absorption wavelengths in a resin, and it is preferable that the absolute value of the difference between the maximum absorption wavelengths of the dye (U1) and the dye (U2) in the resin be 10 nm or more and 15 nm or less, even preferably 10 nm or more and 14 nm or less.

Using UV dyes having different maximum absorption wavelengths in combination enables light shielding of ultraviolet light with small contents.

Examples of the dye (U) include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among these examples, an oxazole dye and a merocyanine dye are preferable and a merocyanine dye is even preferable.

Furthermore, from the viewpoint of obtaining an optical filter that is superior in light resistance, it is particularly preferable to use two or more kinds of merocyanine dyes having different maximum absorption wavelengths. The NIR dye (A) is prone to deteriorate when used together with a UV dye, but this can be prevented by using two or more kinds of merocyanine dyes as UV dyes in combination.

A merocyanine dye represented by the following Formula (M) is particularly preferable as the dye (U):

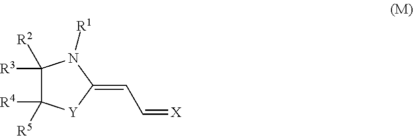

The symbols in Formula (M) have the following meanings:

R¹ represents a monovalent hydrocarbon group having a carbon number of 1 to 12 that may include a substituent.

Preferable examples of the substituent include an alkoxy group, an acyl group, an acyloxy group, a cyano group, a dialkylamino group, and a chlorine atom. It is preferable that the carbon number of the alkoxy group, the acyl group, the acyloxy group, and the dialkylamino group be 1 to 6.

Specific, preferable examples of R¹ including no substituent include an alkyl group having a carbon number of 1 to 12 part of whose hydrogen atoms may be replaced by an aliphatic ring, an aromatic ring, or an alkenyl group, a cycloalkyl group having a carbon number of 3 to 8 part of whose hydrogen atoms may be replaced by an aromatic ring, an alkyl group, or an alkenyl group, and an aryl group having a carbon number of 6 to 12 part of whose hydrogen atoms may be replaced by an aliphatic ring, an alkyl group, or an alkenyl group.

In the case where R¹ is an unsubstituted alkyl group, that alkyl group may be either linear or branched and its carbon number is even preferably 1 to 6.

In the case where R¹ is an alkyl group having a carbon number of 1 to 12 part of whose hydrogen atoms are replaced by an aliphatic ring, an aromatic ring, or an alkenyl group, it is even preferably an alkyl group having a carbon number of 1 to 4 and having a cycloalkyl group having a carbon number of 3 to 6 or a phenyl-group-replaced alkyl group having a carbon number of 1 to 4, and particularly preferably a phenyl-group-replaced alkyl group having a carbon number of 1 or 2. The phrase “ phenyl-group-replaced alkyl group” or “alkyl group replaced by an alkenyl group” means a group that is a phenyl or an alkenyl group as a whole but has no unsaturated bond between position 1 and position 2, examples of which include an aryl group and a 3-butenyl group.

Preferable examples of R¹ include an alkyl group having a carbon number of 1 to 6 part of whose hydrogen atoms may be replaced by a cycloalkyl group or a phenyl group. Particularly preferable examples of le include an alkyl group having a carbon number of 1 to 6, specific examples of which include a methyl group, an ethyl group, an n-propyl group, an isopropyl group, an n-butyl group, an isobutyl group, and a t-butyl group.

R² to R⁵ represent, independently of each other, a hydrogen atom, a halogen atom, an alkyl group having a carbon number of 1 to 10, or an alkoxy group having a carbon number of 1 to 10. It is preferable that the carbon number of the alkyl group and the alkoxy group be 1 to 6, even preferably 1 to 4.

It is preferable that at least one of R² and R³ be an alkyl group and it is even preferable that both of them be an alkyl group. In the case where R² or R³ is not an alkyl group, it is preferable that R² or R³ be a hydrogen atom. It is particularly preferable that both of R² and R³ be an alkyl group having a carbon number of 1 to 6.

It is preferable that at least one of R⁴ and R⁵ be a hydrogen atom and it is even preferable that both of them be a hydrogen atom. In the case where R⁴ or R⁵ is not a hydrogen atom, it is preferable that R⁴ or R⁵ be an alkyl group having a carbon number of 1 to 6.

Y represents a methylene group replaced by R⁶ and R⁷, or an oxygen atom.

R⁶ and R⁷ represent, independently of each other, a hydrogen atom, a halogen atom, an alkyl group having a carbon number of 1 to 10, or an alkoxy group having a carbon number of 1 to 10.

X represents one of divalent groups represented by (X1) to (X5).

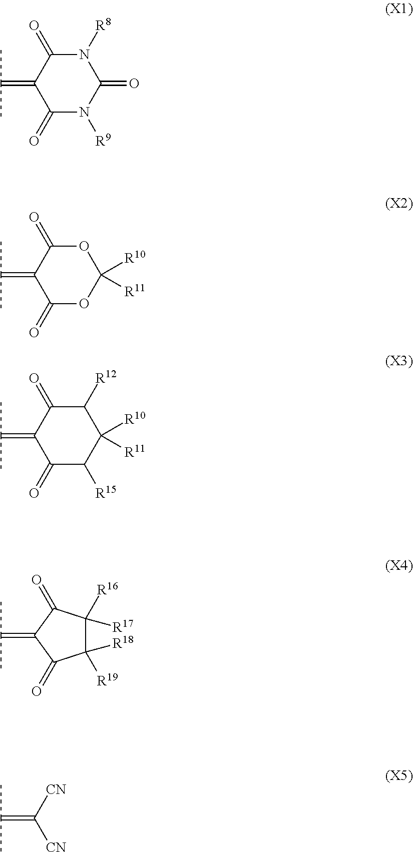

R⁸ and R⁹ represent, independently of each other, a monovalent hydrocarbon group having a carbon number of 1 to 12 that may include a substituent, and R¹⁰ to R¹⁹ represent, independently of each other, a hydrogen atom or a monovalent hydrocarbon group having a carbon number of 1 to 12 that may include a substituent:

Examples of the substituents for R⁸ to R¹⁹ are the same as those for R¹, and preferable modes of the former are the same as those of the latter. In the case where each of R⁸ to R¹⁹ represents a hydrocarbon group not including a substituent, they may be in the same mode as R₁ not including a sub stituent.

In Formula (X1), R⁸ and R⁹ may be different groups but it is preferable that R⁸ and R⁹ be the same group. In the case where R⁸ and R⁹ are unsubstituted alkyl groups, R⁸ and R⁹ may be either linear or branched and their carbon number is preferably 1 to 6.

It is preferable that each of R⁸ and R⁹ be an alkyl group having a carbon number of 1 to 6 part of whose hydrogen atoms may be replaced by a cycloalkyl group or a phenyl group. It is particularly preferable that each of le and R⁹ be an alkyl group having a carbon number of 1 to 6, specific examples of which include a methyl group, an ethyl group, an n-propyl group, an isopropyl group, n-butyl group, an isobutyl group, and a t-butyl group.

In Formula (X2), it is preferable that each of R¹⁰ and R¹¹ be an alkyl group having a carbon number of 1 to 6 and it is particularly preferable that they be the same alkyl group.

In Formula (X3), it is preferable that each of R¹² and R¹⁵ be a hydrogen atom or an alkyl group having a carbon number of 1 to 6 that does not include a substituent. It is preferable that R¹³ and R¹⁴ which are two groups connected to the same carbon atom each be a hydrogen atom or an alkyl group having a carbon number of 1 to 6.

In Formula (X4), it is preferable that each of two groups R¹⁶ and R¹⁷ which are connected to the same carbon atom and each of two groups R¹⁸ and R¹⁹ which are connected to the same carbon atom be a hydrogen atom or an alkyl group having a carbon number of 1 to 6.

Preferable examples of a compound represented by Formula (M) include a compound in which Y is an oxygen atom and X is the group (X1), (X2), or (X5), and a compound in which Y is an unsubstituted methylene group and X is the group (X1), (X2), or (X5).

Specific examples of the compound (M) that can be used as the dye (U) include compounds shown in the following tables.

TABLE 1

| Dye symbol | R¹ | R² | R³ | R⁴ | R⁵ | Y | X | R¹⁰ | R¹¹ |
|---|---|---|---|---|---|---|---|---|---|
| M-1-1 | —CH(CH₃)₂ | H | H | H | H | —O— | X5 | — | — |
| M-1-2 | —CH(CH₃)₂ | H | H | H | H | —CH₂— | X5 | — | — |
| M-1-3 | —CH(CH₃)₂ | H | H | H | H | —O— | X2 | —CH₃ | —CH₃ |
| M-1-4 | —CH(CH₃)₂ | H | H | H | H | —CH₂— | X2 | —CH₃ | —CH₃ |
| M-1-5 | —CH₃ | H | H | H | H | —O— | X5 | — | — |
| M-1-6 | —CH₃ | H | H | H | H | —CH₂— | X5 | — | — |
| M-1-7 | —CH₃ | H | H | H | H | —O— | X2 | —CH₃ | —CH₃ |
| M-1-8 | —CH₃ | H | H | H | H | —CH₂— | X2 | —CH₃ | —CH₃ |
| M-1-9 | —C₂H₅ | H | H | H | H | —O— | X5 | — | — |
| M-1-10 | —C₂H₅ | H | H | H | H | —CH₂— | X5 | — | — |
| M-1-11 | —C₂H₅ | H | H | H | H | —O— | X2 | —CH₃ | —CH₃ |
| M-1-12 | —C₂H₅ | H | H | H | H | —CH₂— | X2 | —CH₃ | —CH₃ |
| M-1-13 | —nC₃H₇ | H | H | H | H | —O— | X5 | — | — |
| M-1-14 | —nC₃H₇ | H | H | H | H | —CH₂— | X5 | — | — |
| M-1-15 | —nC₃H₇ | H | H | H | H | —O— | X2 | —CH₃ | —CH₃ |
| M-1-16 | —nC₃H₇ | H | H | H | H | —CH₂— | X2 | —CH₃ | —CH₃ |
| M-1-17 | H | H | H | H | H | —O— | X5 | — | — |
| M-1-18 | H | H | H | H | H | —CH₂— | X5 | — | — |
| M-1-19 | H | H | H | H | H | —O— | X2 | —CH₃ | —CH₃ |
| M-1-20 | H | H | H | H | H | —CH₂— | X2 | —CH₃ | —CH₃ |

TABLE 2

| Dye symbol | R¹ | R² | R³ | R⁴ | R³ | Y | X | R¹⁰ | R¹¹ |
|---|---|---|---|---|---|---|---|---|---|
| M-1-21 | —CH(CH₃)₂ | —CH₃ | —CH₃ | H | H | —O— | X5 | — | — |
| M-1-22 | —CH(CH₃)₂ | —CH₃ | —CH₃ | H | H | —CH₂— | X5 | — | — |
| M-1-23 | —CH(CH₃)₂ | —CH₃ | —CH₃ | H | H | —O— | X2 | —CH₃ | —CH₃ |
| M-1-24 | —CH(CH₃)₂ | —CH₃ | —CH₃ | H | H | —CH₂— | X2 | —CH₃ | —CH₃ |
| M-1-25 | —CH₃ | —CH₃ | —CH₃ | H | H | —O— | X5 | — | — |
| M-1-26 | —CH₃ | —CH₃ | —CH₃ | H | H | —CH₂— | X5 | — | — |
| M-1-27 | —CH₃ | —CH₃ | —CH₃ | H | H | —O— | X2 | —CH₃ | —CH₃ |
| M-1-28 | —CH₃ | —CH₃ | —CH₃ | H | H | —CH₂— | X2 | —CH₃ | —CH₃ |
| M-1-29 | —C₂H₅ | —CH₃ | —CH₃ | H | H | —O— | X5 | — | — |
| M-1-30 | —C₂H₅ | —CH₃ | —CH₃ | H | H | —CH₂— | X5 | — | — |
| M-1-31 | —C₂H₅ | —CH₃ | —CH₃ | H | H | —O— | X2 | —CH₃ | —CH₃ |
| M-1-32 | —C₂H₅ | —CH₃ | —CH₃ | H | H | —CH₂— | X2 | —CH₃ | —CH₃ |
| M-1-33 | —nC₃H₇ | —CH₃ | —CH₃ | H | H | —O— | X5 | — | — |
| M-1-34 | —nC₃H₇ | —CH₃ | —CH₃ | H | H | —CH₂— | X5 | — | — |
| M-1-35 | —nC₃H₇ | —CH₃ | —CH₃ | H | H | —O— | X2 | —CH₃ | —CH₃ |
| M-1-36 | —nC₃H₇ | —CH₃ | —CH₃ | H | H | —CH₂— | X2 | —CH₃ | —CH₃ |
| M-1-37 | H | —CH₃ | —CH₃ | H | H | —O— | X5 | — | — |
| M-1-38 | H | —CH₃ | —CH₃ | H | H | —CH₂— | X5 | — | — |
| M-1-39 | H | —CH₃ | —CH₃ | H | H | —O— | X2 | —CH₃ | —CH₃ |
| M-1-40 | H | —CH₃ | —CH₃ | H | H | —CH₂— | X2 | —CH₃ | —CH₃ |

Specific examples of the compound (M) that can be used as the dye (U1) include compounds shown in the following table.

TABLE 3

| Dye symbol | R¹ | R² | R³ | R⁴ | R⁵ | Y | X | R¹⁰ | R¹¹ |
|---|---|---|---|---|---|---|---|---|---|
| M-1-3 | —CH(CH₃)₂ | H | H | H | H | —O— | X2 | —CH₃ | —CH₃ |
| M-1-4 | —CH(CH₃)₂ | H | H | H | H | —CH₂— | X2 | —CH₃ | —CH₃ |
| M-1-7 | —CH₃ | H | H | H | H | —O— | X2 | —CH₃ | —CH₃ |
| M-1-8 | —CH₃ | H | H | H | H | —CH₂— | X2 | —CH₃ | —CH₃ |
| M-1-11 | —C₂H₅ | H | H | H | H | —O— | X2 | —CH₃ | —CH₃ |
| M-1-12 | —C₂H₅ | H | H | H | H | —CH₂— | X2 | —CH₃ | —CH₃ |
| M-1-15 | —nC₃H₇ | H | H | H | H | —O— | X2 | —CH₃ | —CH₃ |
| M-1-16 | —nC₃H₇ | H | H | H | H | —CH₂— | X2 | —CH₃ | —CH₃ |
| M-1-19 | H | H | H | H | H | —O— | X2 | —CH₃ | —CH₃ |
| M-1-20 | H | H | H | H | H | —CH₂— | X2 | —CH₃ | —CH₃ |
| M-1-23 | —CH(CH₃)₂ | —CH₃ | —CH₃ | H | H | —O— | X2 | —CH₃ | —CH₃ |
| M-1-24 | —CH(CH₃)₂ | —CH₃ | —CH₃ | H | H | —CH₂— | X2 | —CH₃ | —CH₃ |
| M-1-27 | —CH₃ | —CH₃ | —CH₃ | H | H | —O— | X2 | —CH₃ | —CH₃ |
| M-1-28 | —CH₃ | —CH₃ | —CH₃ | H | H | —CH₂— | X2 | —CH₃ | —CH₃ |
| M-1-31 | —C₂H₅ | —CH₃ | —CH₃ | H | H | —O— | X2 | —CH₃ | —CH₃ |
| M-1-32 | —C₂H₅ | —CH₃ | —CH₃ | H | H | —CH₂— | X2 | —CH₃ | —CH₃ |
| M-1-35 | —nC₃H₇ | —CH₃ | —CH₃ | H | H | —O— | X2 | —CH₃ | —CH₃ |
| M-1-36 | —nC₃H₇ | —CH₃ | —CH₃ | H | H | —CH₂— | X2 | —CH₃ | —CH₃ |
| M-1-39 | H | —CH₃ | —CH₃ | H | H | —O— | X2 | —CH₃ | —CH₃ |
| M-1-40 | H | —CH₃ | —CH₃ | H | H | —CH₂— | X2 | —CH₃ | —CH₃ |

Specific examples of the compound (M) that can be used as the dye (U2) include compounds shown in the following table.

TABLE 4

| Dye symbol | R¹ | R² | R³ | R⁴ | R⁵ | Y | X | R⁸ | R⁹ |
|---|---|---|---|---|---|---|---|---|---|
| M-1-1 | —CH(CH₃)₂ | H | H | H | H | —O— | X5 | — | — |
| M-1-2 | —CH(CH₃)₂ | H | H | H | H | —CH₂— | X5 | — | — |
| M-1-5 | —CH₃ | H | H | H | H | —O— | X5 | — | — |
| M-1-6 | —CH₃ | H | H | H | H | —CH₂— | X5 | — | — |
| M-1-9 | —C₂H₅ | H | H | H | H | —O— | X5 | — | — |
| M-1-10 | —C₂H₅ | H | H | H | H | —CH₂— | X5 | — | — |
| M-1-13 | —nC₃H₇ | H | H | H | H | —O— | X5 | — | — |
| M-1-14 | —nC₃H₇ | H | H | H | H | —CH₂— | X5 | — | — |
| M-1-17 | H | H | H | H | H | —O— | X5 | — | — |
| M-1-18 | H | H | H | H | H | —CH₂— | X5 | — | — |
| M-1-21 | —CH(CH₃)₂ | —CH₃ | —CH₃ | H | H | —O— | X5 | — | — |
| M-1-22 | —CH(CH₃)₂ | —CH₃ | —CH₃ | H | H | —CH₂— | X5 | — | — |
| M-1-25 | —CH₃ | —CH₃ | —CH₃ | H | H | —O— | X5 | — | — |
| M-1-26 | —CH₃ | —CH₃ | —CH₃ | H | H | —CH₂— | X5 | — | — |
| M-1-29 | —C₂H₅ | —CH₃ | —CH₃ | H | H | —O— | X5 | — | — |
| M-1-30 | —C₂H₅ | —CH₃ | —CH₃ | H | H | —CH₂— | X5 | — | — |
| M-1-33 | —nC₃H₇ | —CH₃ | —CH₃ | H | H | —O— | X5 | — | — |
| M-1-34 | —nC₃H₇ | —CH₃ | —CH₃ | H | H | —CH₂— | X5 | — | — |
| M-1-37 | H | —CH₃ | —CH₃ | H | H | —O— | X5 | — | — |
| M-1-38 | H | —CH₃ | —CH₃ | H | H | —CH₂— | X5 | — | — |
| M-2-1 | —CH₃ | H | H | H | H | —O— | X1 | —CH₃ | —CH₃ |
| M-2-2 | —C₂H₅ | H | H | H | H | —O— | X1 | —CH₃ | —CH₃ |
| M-2-3 | —nC₃H₇ | H | H | H | H | —O— | XI | —CH₃ | —CH₃ |
| M-2-4 | —CH(CH₃)₂ | H | H | H | H | —O— | X1 | —CH₃ | —CH₃ |
| M-2-5 | —CH₃ | —CH₃ | —CH₃ | H | H | —O— | X1 | —CH₃ | —CH₃ |
| M-2-6 | —C₂H₅ | —CH₃ | —CH₃ | H | H | —O— | X1 | —CH₃ | —CH₃ |
| M-2-7 | —nC₃H₇ | —CH₃ | —CH₃ | H | H | —O— | X1 | —CH₃ | —CH₃ |
| M-2-8 | —CH(CH₃)₂ | —CH₃ | —CH₃ | H | H | —O— | X1 | —CH₃ | —CH₃ |

Among the above examples of the compound (M), the compounds (M-1-2), (M-1-10), (M-1-24), (M-1-28), etc. are preferable from the viewpoints of solubility in resin or a solvent, visible light transparency, and, in particular, satisfaction of the optical characteristic (iii-1). In the case where two kinds of compounds (M) having different maximum absorption wavelengths are used in combination, a combination of the compounds (M-1-28) and (M-1-2), a combination of the compounds (M-1-28) and (M-1-10), a combination of the compounds (M-1-24) and (M-1-2), and a combination of the compounds (M-1-24) and (M-1-10) are preferable. It is noted that the compound (M) can be manufactured by a known method.

It is preferable that the content of the UV dye (U) in the resin film be in such a range that the product of the total content of the dye (U) and the dye (A) and the thickness of the resin film be 100 (mass %·μm) or less, even preferably 80 (mass %˜μm) or less, further preferably 70 (mass %˜μm) or less, and particularly preferably 50 (mass %˜μm) or less. As the addition amount of the UV dye increases, the resin properties deteriorate, resulting in reduction of the adhesion to the dielectric multilayer film. Furthermore, the glass transition temperature of the resin lowers, posing a concern about heat resistance. These problems can be prevented if the product of the total content of the dyes and the thickness of the resin film is in the above range. Furthermore, from the viewpoint of satisfying desired spectral characteristics, it is preferable that the product of the total content and the thickness be 10 (mass %·μm) or more, even preferably 15 (mass %˜μm) or more.

To allow the product to fall within the above range, it is preferable that the content of the UV dye (U) in the resin film be 5 to 25 parts by mass with respect to 100 parts by mass of the resin, even preferably 5 to 20 parts by mass. In the case where the content of the UV dye (U) is in this range, the above problems can be avoided without lowering the resin properties.

<NIR Dye>

In the optical filter according to the present invention, the substrate includes the above-described dye (U) and dye (A).

The dye (A) is an NIR dye having a maximum absorption wavelength in a range of 600 to 800 nm in dichloromethane. Having such a dye, the optical filter can cut infrared light effectively.

It is preferable that the dye (A) be at least one kind selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenyl methane dye, an aminium dye, and diimonium dye.

It is preferable that the dye (A) contain at least one dye selected from a squarylium dye, a phthalocyanine dye, and a cyanine dye. Among these NIR dyes, a squarylium dye and a cyanine dye are preferable from the spectral point of view, and a phthalocyanine dye is preferable from the viewpoint of durability.

It is preferable that the squarylium dye be a compound represented by the following Formula (I):

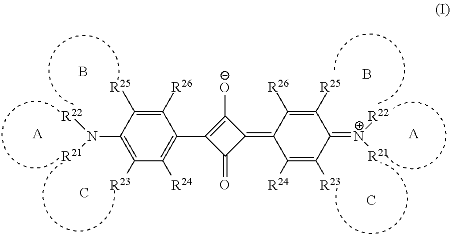

Symbols in Formula (1) have the following meanings:

R²⁴ and R²⁶ represent, independently of each other, a hydrogen atom, a halogen atom, an hydroxyl group, an alkyl group having a carbon number of 1 to 6, an alkoxy group having a carbon number of 1 to 6, an acyloxy group having a carbon number of 1 to 10, —NR²⁷R²⁸ (R²⁷ and R²⁸ represent, independently of each other, a hydrogen atom, an alkyl group having a carbon number of 1 to 20, —C(═O)—R²⁹ (R²⁹ represents a hydrogen atom, an alkyl group having a carbon number of 1 to 20 that may include a substituent, an aryl group having a carbon number of 6 to 11 that may include a sub stituent, or an alaryl group having a carbon number of 7 to 18 that may include a substituent and may have an oxygen atom between carbon atoms), —NHR³⁰ or SO₂—R³⁰ (each R³⁰ represents a hydrocarbon group having a carbon number of 1 to 25 whose one or more hydrogen atoms may be replaced by a halogen atom, an hydroxy group, a carboxy group, a sulfo group, or a cyano group and that may include an unsaturated bond, an oxygen atom, or a saturated or unsaturated ring structure between carbon atoms), or a group represented by the following Formula (S) (R⁴¹ and R⁴² represent, independently of each other, a hydrogen atom, a halogen atom, or an alkyl group having a carbon number of 1 to 10 or an alkoxy group having a carbon number of 1 to 10 and k represents 2 or 3).

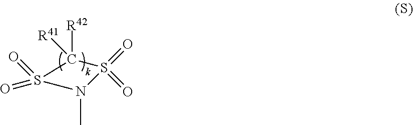

R²¹ and R²², R²² and R²⁵, and R²¹ and R²³ may form a heterocycle A, a heterocycle B, and a heterocycle C each having five or six members, respectively, together with a nitrogen atom by connecting to each other.

R²¹ and R²² form, in the case where the heterocycle A is formed, as a divalent group -Q- as a result of their connection, an alkylene group or an alkyleneoxy group whose hydrogen atom may be replaced by an alkyl group having a carbon number of 1 to 6, an aryl group having a carbon number of 6 to 10, or an acyloxy group having a carbon number of 1 to 10 that may include a substituent.

R²² and R²⁵ form, in the case where the heterocycle B is formed, as a result of their connection, and R²¹ and R²³ form, in the case where the heterocycle C is formed, as a result of their connection, divalent groups —X¹—Y¹— and —X²—Y²—(X¹ and X² connect the nitrogen), respectively, and each of X¹ and X² is represented by the^{'} following Formula (1x) or (2x) and each of Y¹ and Y² is represented by one of the following Formulae (1y) to (5y), and in the case where each of X¹ and X² is a group represented by the following Formula (2x), each of Y¹ and Y² may be a single bond in which case an oxygen atom may exist between carbon atoms.

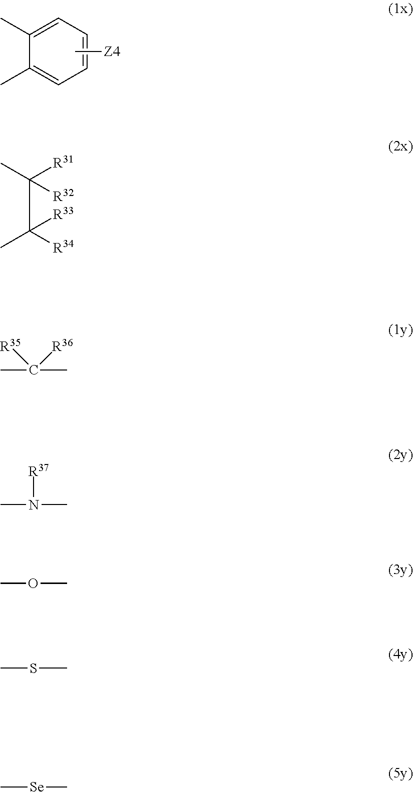

In Formula (1x), four Zs represent, independently of each other, a hydrogen atom, an hydroxy group, an alkyl group having a carbon number of 1 to 6, an alkoxy group having a carbon number of 1 to 6, or —NR³⁸R³⁹ (R³⁸ and R³⁹ represent, independently of each other, a hydrogen atom or an alkyl group having a carbon number of 1 to 20), R³¹ to R³⁶ represent, independently of each other, a hydrogen atom, an alkyl group having a carbon number of 1 to 6, or an aryl group having a carbon number of 6 to 10, and R³⁷ represents an alkyl group having a carbon number of 1 to 6 or an aryl group having a carbon number of 6 to 10.

R²⁷, R²⁸, R²⁹, R³¹ to R³⁷, R²¹ to R²³ not forming a heterocycle, and R²⁵ may form a 5-membered ring or a 6-membered ring by connecting to one of the others, and R³¹ and R³⁶ or R³¹ and R³⁷ may connect to each other directly.

R²¹ and R²² not forming a heterocycle represent, independently of each other, a hydrogen atom, an alkyl group having a carbon number of 1 to 6 and that may include a substituent, an allyl group that may include a substituent, an aryl group having a carbon number of 6 to 11 and that may include a substituent, or an alaryl group having a carbon number of 6 to 11 and that may include a substituent, and R²³ and R²⁵ not forming a heterocycle represent, independently of each other, a hydrogen atom, a halogen atom, an alkyl group having a carbon number of 1 to 6, or an alkoxy group having a carbon number of 1 to 6.

From the viewpoint that the visible light transmittance can be made high, it is preferable that the compound (I) be, for example, a compound represented by the following Formula (I-1):

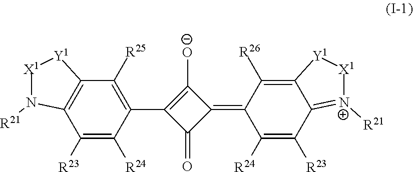

The symbols used in Formula (I-1) have the same meanings as the same symbols used in Formula (1) and preferable modes of what are represented by the former are also the same as those of the latter.

In the compound (I-1), X¹ is preferably the group (2x) and Y¹ is preferably a single bond or the group (1y). In this case, R³¹ to R³⁶ are preferably a hydrogen atom or an alkyl group having a carbon number of 1 to 3, and even preferably a hydrogen atom or a methyl group. Specific examples of —Y¹—X¹— include divalent organic groups represented by the following Formulae (11-1) to (12-3).

—C(CH₃)₂—CH(CH₃)— (11-1)

—C(CH₃)₂—CH₂— (11-2)

—C(CH₃)₂—CH(C₂H₅)— (11-3)

—C(CH₃)₂—C(CH₃)(nC₃H₇)— (11-4)

—C(CH₃)₂—CH₂—CH₂ (12-1)

—C(CH₃)₂—CH₂—CH(CH₃)— (12-2)

—C(CH₃)₂—CH(CH₃)—CH₂— (12-3)

In the compound (1-1), from the viewpoints of solubility, heat resistance, and the steepness of a variation around the boundary between a visible range and a near-infrared range of a spectral transmittance curve, it is even preferable that R²¹'s be, independently of each other, a group represented by the following Formula (4-1) or (4-2):

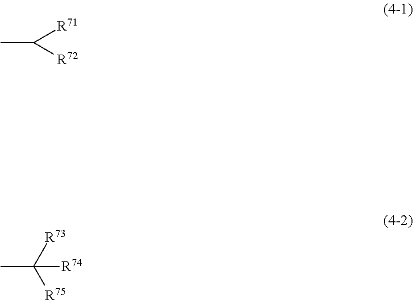

In Formulae (4-1) and (4-2), R⁷¹ to R⁷⁵ represent, independently of each other, a hydrogen atom, a halogen atom, or an alkyl group having a carbon number of 1 to 4.

In the compound (I-1), from the viewpoint of increasing the transmittance of visible light, in particular, light in a wavelength range of 430 to 550 nm, it is preferable that R²⁴′s be —NH—SO₂—R³⁰.

Formula (I-12) shows a compound in which R²⁴'s in the compound (I-1) are —NH—SO₂—R³⁰.

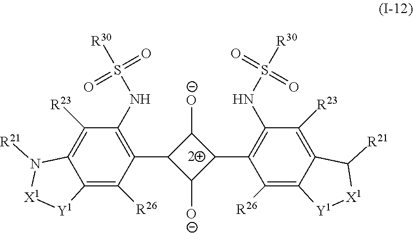

It is preferable that R²³ and R²⁶ of the compound (1-12) be, independently of each other, a hydrogen atom, a halogen atom, an alkyl group having a carbon number of 1 to 6, or an alkoxy group having a carbon number of 1 to 6. It is even preferable that each of R²³ and R²⁶ be a hydrogen atom.

In the compound (I-12), from the viewpoint of weatherability, it is preferable that R³⁰'s be, independently of each other, an alkyl group having a carbon number of 1 to 12 that may have a branch, an alkoxy group having a carbon number of 1 to 12 that may have a branch, or a hydrocarbon group having a carbon number of 6 to 16 that includes an unsaturated ring structure. Examples of the unsaturated ring structure include benzene, toluene, xylene, furan, and benzofuran. It is even preferable that R³⁰'s be, independently of each other, an alkyl group having a carbon number of 1 to 12 that may have a branch or an alkoxy group having a carbon number of 1 to 12 that may have a branch. It is noted that in each group represented by R³⁰ all or part of the hydrogen atoms may be replaced by a halogen atom, in particular, a fluorine atom.

The compound (I) can be manufactured by known methods described in U.S. Pat. No. 5,543,086, US-A-2014/0061505, and WO 2014/088063.

Examples of the phthalocyanine dye include ones described in Japanese Patent No. 5,884,953 and WO 2019/168090.

Preferable examples of the cyanine dye include a compound represented by the following Formula (A1) or (A2):

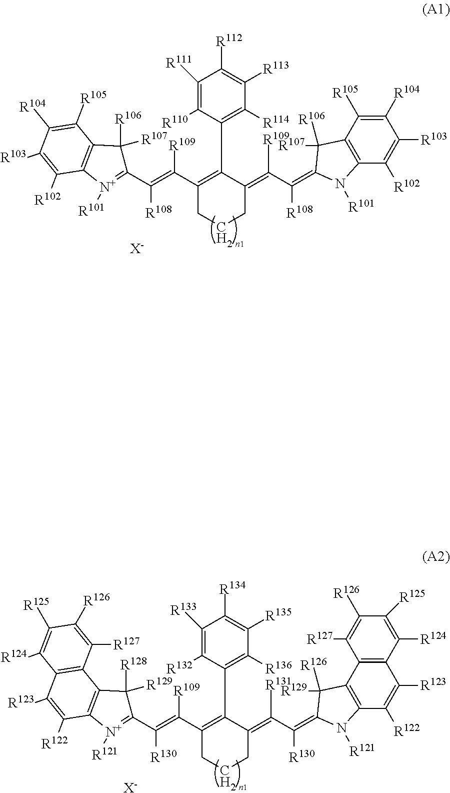

The symbols in Formulae (A1) and (A2) have the following meanings:

R¹⁰¹ to R¹⁰⁹ and R¹²¹ to R¹³¹ represent, independently of each other, a hydrogen atom. a halogen atom, an alkyl group having a carbon number of 1 to 15 and that may include a substituent, an alkoxy group having a carbon number of 1 to 15 and that may include a substituent, or an aryl group having a carbon number of 5 to 20. R¹¹⁰ to R¹¹⁴ and R¹³² to R¹³⁶ represent, independently of each other, a hydrogen atom, a halogen atom, an alkyl group having a carbon number of 1 to 15, or an alkoxy group having a carbon number of 1 to 15.

X⁻ represents a monovalent anion.

Symbols n1 and n2 represent, independently of each other, 0 or 1. A hydrogen atom connected to the carbon ring including —(CH₂)ₙ₁— or the carbon ring including —(CH₂)ₙ₂— may be replaced by a halogen atom, an alkyl group having a carbon number of 1 to 15 that may include a substituent, or an aryl group having a carbon number of 5 to 20 that may include a substituent.

In Formulae (A1) and (A2), it is preferable that R₁₀₂ to R₁₀₅, R₁₀₈, R₁₀₉, R¹²² to R¹²⁷, R¹³⁰, and R¹³¹ be, independently of each other, a hydrogen atom, an alkyl group having a carbon number of 1 to 15, an alkoxy group having a carbon number of 1 to 15, or an aryl group having a carbon number of 5 to 20. Among these examples, a hydrogen atom is even preferable from the viewpoint that high visible light transmittance can be obtained.

In Formulae (A1) and (A2), it is preferable that R¹¹⁰ to R¹¹⁴ and R¹³² to R¹³⁶ be, independently of each other, a hydrogen atom or an alkyl group having a carbon number of 1 to 15. Among these examples, a hydrogen atom is even preferable from the viewpoint that high visible light transmittance can be obtained.

It is preferable that R¹⁰⁶, R¹⁰⁷, R¹²⁸, and R¹²⁹ be, independently of each other, a hydrogen atom, an alkyl group having a carbon number of 1 to 15, or an aryl group having a carbon number of 5 to 20 (it may include a chain, cyclic, or branched alkyl group), even preferably a hydrogen atom or an alkyl group having a carbon number of 1 to 15. It is preferable that R¹⁰⁶ and R¹⁰⁷ be the same group and R¹²⁸ and R¹²⁹ be the same group.

It is preferable that R¹⁰¹ and R¹²¹ be an alkyl group having a carbon number of 1 to 15 or an aryl group having a carbon number of 5 to 20. From the viewpoint of maintaining high visible light transmittance in a transparent resin as in a solution, it is preferable that R¹⁰¹ and R¹²¹ be an alkyl group having a carbon number of 1 to 15.

Examples of X⁻ include I⁻, BF₄⁻, PF₆⁻, ClO₄⁻, and anions represented by the following Formula (X1) or (X2), among which BF₄⁻and PF₆⁻ are preferable.

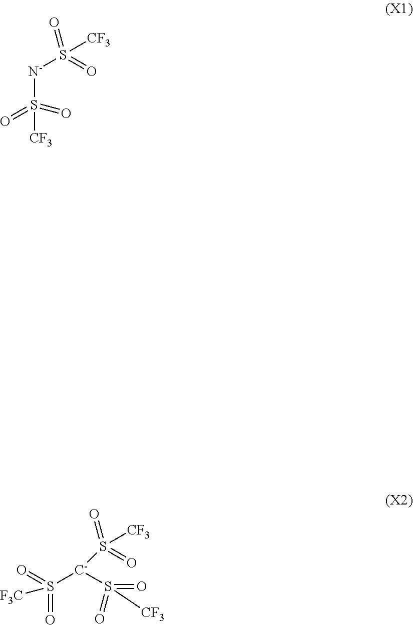 [SMILES: O=S(=O)([N-]S(=O)(=O)C(F)(F)F)C(F)(F)F ; O=S(=O)([C-](S(=O)(=O)C(F)(F)F)S(=O)(=O)C(F)(F)F)C(F)(F)F]

In the following description, the portion of the dye (A1) excluding R¹⁰¹ to R¹¹⁴ is also referred to as a framework (A1). This kind of notification also applies to the other dyes.

A compound in which n1 in Formula (A1) is 1 is represented by the following Formula (A11) and a compound in which n1 in Formula (A1) is 0 is represented by the following Formula (A12):

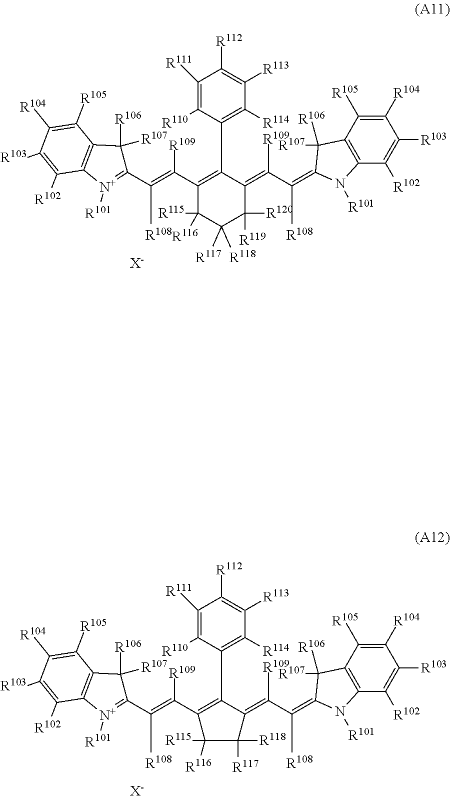

In Formulae (A11) and (A12), R¹⁰¹ to R¹¹⁴ and X⁻ are the same as in Formula (A1). R¹¹⁵ to R¹²⁰ represent, independently of each other, a hydrogen atom, a halogen atom, an alkyl group having a carbon number of 1 to 15 and that may include a substituent, an alkoxy group having a carbon number of 1 to 15 and that may include a substituent, or an aryl group having a carbon number of 5 to 20. It is preferable that R¹¹⁵ to R¹²⁰ be, independently of each other, a hydrogen atom, an alkyl group having a carbon number of 1 to 15, or an aryl group having a carbon number of 5 to 20 (it may include a chain, cyclic, or branched alkyl group), even preferably a hydrogen atom or an alkyl group having a carbon number of 1 to 15. It is preferable that R¹¹⁵ to R¹²⁰ be the same group.

A compound in which n2 in Formula (A2) is 1 is represented by the following Formula (A21) and a compound in which n2 in Formula (A2) is 0 is represented by the following Formula (A22):

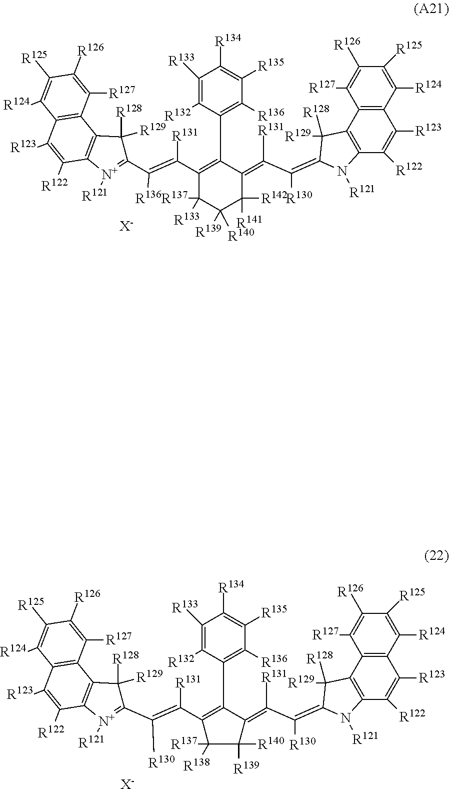

In Formulae (A21) and (A22), R¹²¹ to R¹³⁶ and X⁻ are the same as in Formula (A2). R¹³⁷ to R¹⁴² represent, independently of each other, a hydrogen atom, a halogen atom, an alkyl group having a carbon number of 1 to 15 and that may include a substituent, an alkoxy group having a carbon number of 1 to 15 and that may include a substituent, or an aryl group having a carbon number of 5 to 20. It is preferable that R¹³⁷ to R¹⁴² be, independently of each other, a hydrogen atom, an alkyl group having a carbon number of 1 to 15, or an aryl group having a carbon number of 5 to 20 (it may include a chain, cyclic, or branched alkyl group), even preferably a hydrogen atom or an alkyl group having a carbon number of 1 to 15. It is preferable that R¹³⁷ to R¹⁴² be the same group.

The dyes (A1) and (A2) can be manufactured by, for example, known methods described in “Dyes and Pigments,” 73 (2007), pp. 344-352 and J. Heterocyclic Chem., 42, 959 (2005).

As described above, it is preferable that the content of the NIR dye (A) in the substrate be such that the product of the total content of the dye (U) and the dye (A) and the thickness of the resin film is in the particular range.

From the viewpoint of satisfying the above range requirement, it is preferable that the content of the NIR dye (A) in the resin film be 5 to 25 parts by mass with respect to 100 parts by mass of the resin, even preferably 5 to 20 parts by mass.

### <Substrate Structure>

The substrate of the present filter may have either a single-layer structure or a multilayer structure. There are no particular limitations on the material of the substrate; the material may be either an organic material or an inorganic material as long as it is a transparent material that transmits visible light in a range of 400 to 700 nm.

In the case where the substrate has a single-layer structure, it is preferable that the substrate be a resin substrate that is made of a resin film containing a resin, the UV dye (U), and the NIR dye (A).

In the case where the substrate has a multilayer structure, it is preferable that the substrate have a structure that a resin film containing the UV dye (U) and the NIR dye (A) is laid on or above at least one major surface of a support body. In this structure, it is preferable that the support body be made of a transparent resin or a transparent inorganic material.

It is preferable that the resin be a transparent resin, examples of which include a polyester resin, an acrylic resin, an epoxy resin, an en thiol resin, a polycarbonate resin, a polyether resin, a polyarylate resin, a polysulfone resin, a polyether sulfone resin, a polyparaphenylene resin, a polyarylene ether phosphine oxide resin, a polyamide resin, a polyimide resin, a polyamideimide resin, a polyolefin resin, a cyclic olefin resin, a polyurethane resin, and a polystyrene resin. These resins may be used singly or two or more kinds of them may be used in mixture. Among these examples, a polyimide resin is preferable from the viewpoints that it is high in visible light transmittance and its glass transition temperature is so high that the dyes are made less prone to thermal deterioration.

Preferable examples of the transparent inorganic materials include glass and a crystal material.

Examples of glass that can be used as the support body include an absorption glass (a near-infrared light absorption glass) obtained by making copper ions be contained in a fluorophosphate glass, a phosphate glass, or the like, a soda-lime glass, a borosilicate glass, an alkali-free glass, and a quartz glass. It is preferable that the glass be an absorption glass that is suitable for a purpose; from the viewpoint of absorbing infrared light, a phosphate glass and a fluorophosphate glass are preferable. An alkali glass, an alkali-free glass, and a quartz glass are preferable when it is desired to take in a large amount of red light (600 to 700 nm). It is noted that the term “phosphate glass” includes a silicophosphate glass in which part of its glass framework is made of SiO₂.

A chemically strengthened glass, obtained by replacing alkali metal ions (e.g., Li ions and/or Na ions) having a small ion radius that exist adjacent to a major surface of a glass plate with alkali ions (e.g., Na ions or K ions for Li ions and K ions for Na ions) having a large ion radius by ion exchange at a glass transition temperature or lower, can be used as the glass.

Examples of the crystal materials that can be used to form the support body include birefringent crystals such as quartz, lithium niobate and sapphire.

From the viewpoints of the shape stability that relates to the long-term reliability of optical characteristics, mechanical properties, etc. and the ease of handling during filter manufacture, it is preferable that the support body be made of an inorganic material, particularly preferably glass or sapphire.

The resin film can be formed by preparing a coating liquid by dissolving or dispersing, in a solvent, the dye (U) and the dye (A), a resin or material components of a resin, and components that are mixed when necessary, and applying it to the support body and drying it, and, if necessary, curing it. The support body may be either one included in the present filter or a peelable one that is used only in forming the resin film. It suffices that the solvent be a dispersion medium that enables stable dispersion or a solvent capable of dissolution.

The coating liquid may contain a surfactant to improve voids formed by minute babbles, depressions due to sticking of foreign substances etc., and cissing etc. in a drying step. The coating liquid can be applied by, for example, an immersion coating method, a cast coating method, or spin coating method. The resin film is formed by applying the above-mentioned coating liquid to the support body and then drying it. In the case where the coating liquid contains material components of a transparent resin, curing treatment is performed further such as thermal curing or photocuring.

The resin film can also be manufactured so as to have a film shape by extrusion molding. In the case where the substrate has a single-layer structure made of a resin film containing the dye (U) and the dye (A) (resin substrate), the resin film itself can be used as the substrate. In the case where the substrate has a multilayer structure including the support body, and the resin film containing the dye (U) and the dye (A) and laid on or above at least one major surface of the support body (composite substrate), the substrate can be manufactured by integrating this film with the support body by, for example, thermocompression bonding.

The optical filter may include either one or two or more resin films. In the case where the optical filter includes two or more resin films, the resin films may have either the same structure or different structures.

It is preferable that the thickness of the resin film be 10 μm or less, even preferably 5 μm or less.

In the case where the substrate has a single-layer structure made of a resin film containing the dye (U) and the dye (A) (resin substrate), it is preferable that the thickness of the resin film be 10 μm or less, even preferably 5μm or less.

In the case where the substrate has a multilayer structure including the support body, and the resin film containing the dye (U) and the dye (A) (composite substrate), it is preferable that the thickness of the resin film be 10 μm or less, even preferably 5μm or less. In the case where the resin film includes plural layers, it is preferable that the total thickness of those layers be 20 μm or less, even preferably 10 μm or less.

There are no particular limitations on the shape of the substrate; it may have a block shape, a plate shape, or a film shape.

Furthermore, from the viewpoints of warp deformation that occurs due to a reliability-related variation when a dielectric multilayer film is formed or the ease of handling, it is preferable that the thickness of the substrate be 300 μm or less, even preferably 50 to 300 pm and particularly preferably 70 to 300 μm.

In the case where the substrate is a resin substrate containing a resin and the dyes, it is preferable that the thickness of the substrate be 120 μm or less from the viewpoint of an advantage of height reduction, and 50 μm or more from the viewpoint of reduction of a warp that may occur at the time of formation of a multilayer film. In the case where the substrate is a composite substrate containing a support body and a resin film, it is preferable that the thickness of the substrate be 70 to 110 μm.

### <Dielectric Multilayer Film>

In the present filter, the dielectric multilayer film serves as an outermost layer and is laid on or above at least one major surface of the substrate.

In the present filter, it is preferable that at least one dielectric multilayer film be designed as a near-infrared light reflection layer (hereinafter also referred to as an “NIR reflection layer”). It is preferable that other dielectric multilayer film(s) be designed as an NIR reflection layer, a reflection layer having a reflection range other than a near-infrared range, or an anti-reflection layer.

The NIR reflection layer is a dielectric multilayer film that is designed so as to interrupt near-infrared light. For example, the NIR reflection layer has such wavelength selectivity as to transmit visible light and reflect mainly light in a near-infrared range other than a light interruption range of the resin film. The reflection range of the NIR reflection layer may include a near-infrared light interruption range of the resin film. The NIR reflection layer may be designed appropriately so as to interrupt light in a wavelength range other than a near-infrared range, such as light in a near-ultraviolet range, regardless of the characteristics of the NIR reflection.

For example, the NIR reflection layer is a dielectric multilayer film that is formed by laying a dielectric film having a lower refractive index (low refractive index films) and a dielectric film having a higher refractive index (high refractive index films) alternately. It is preferable that the refractive index of the high refractive index films be 1.6 or more, even preferably 2.2 to 2.5. Examples of a material of the high refractive index films include Ta₂O₅, TiO₂, and Nb₂O₅, among which TiO₂ is preferable from the viewpoints of the ease of film formation, the reproducibility of a refractive index etc., and stability.

On the other hand, it is preferable that the refractive index of the low refractive index films be less than 1.6, even preferably 1.45 or more and less than 1.55. Examples of a material of the low refractive index films include SiO₂ and SiOₓN_{y}. SiO₂ is preferable from the viewpoints of reproducibility in film formation, stability, and economy.

Furthermore, it is preferable that the transmittance of the NIR reflection layer vary steeply in a boundary wavelength range between a transmission range and an interruption range. To this end, it is preferable that the total number of lamination layers of the dielectric multilayer film constituting the reflection layer be 15 or more, even preferably 25 or more, and further preferably 30 or more. However, since a warp or the like occurs or the thickness increases unduly if the total number of lamination layers is too large, it is preferable that the total number of lamination layers be 100 or less, even preferably 75 or less, and further preferably 60 or less. It is preferable that the total thickness of the reflection layer be 2 to 10 um.

If the total number of lamination layers and the thickness of the dielectric multilayer film are within the above ranges, the NIR reflection layer satisfies a requirement of miniaturization and makes it possible to suppress the incident angle dependence while maintaining high productivity. Incidentally, vacuum film forming processes such as a CVD method, a sputtering method, and a vacuum vapor deposition method and wet film forming processes such as a spray method and a dip method can be used for formation of the dielectric multilayer film.

The NIR reflection layer may accomplish prescribed optical characteristics by either a single layer (one dielectric multilayer film) or two or more layers. In the case where two or more reflection layers are provided, they may be either the same or different in structure. In the case where two or more reflection layers are provided, usually plural reflection layers having different reflection bands are employed as them. In the case where two reflection layers are provided, they may be such that one is a near-infrared reflection layer that interrupts light in a shorter wavelength band of a near-infrared range, and the other is a near-infrared/near-ultraviolet reflection layer that interrupts light in both of a longer wavelength band of that near-infrared range and a near-ultraviolet range.

Examples of the anti-reflection layer include a dielectric multilayer film, an intermediate refractive index medium, and a moss eye structure in which the refractive index varies gradually. Among these examples, a dielectric multilayer film is preferable from the viewpoints of optical efficiency and productivity. The anti-reflection layer is formed by laying dielectric films alternately like the reflection layer is.

For example, the present filter may be equipped with, as another constituent element, a constituent element (layer) that provides absorption by inorganic fine particles or the like to control transmission and absorption of light in a particular wavelength range. Specific examples of a material of the inorganic fine particles include ITO (indium tin oxides), ATO (antimony-doped tin oxides), cesium tungstate, and lanthanum boride. Since ITO fine particles and cesium tungstate fine particles are high in visible light transmittance and are light absorptive in a wide infrared wavelength range that is longer than 1,200 nm, they can be used in a case that such infrared light needs to be interrupted.

In the case where the present filter is used in, for example, an imaging apparatus such as a digital still camera, it can provide an imaging apparatus that is superior in color reproducibility. An imaging apparatus provided with the present filter is equipped with a solid-state imaging device, an imaging lens, and the present filter. For example, the present filter can be used in such a manner as to be disposed between the imaging lens and the solid-state imaging device or directly stuck to, for example, the solid-state imaging device or the imaging lens of the imaging apparatus via an adhesive layer.

### INVENTIVE EXAMPLES

Next, the present invention will be described in more detail using Inventive Examples.

An ultraviolet/visible spectral photometer (type “UH-4150” produced by Hitachi High-Tech Corporation) was used for measurement of various optical characteristics.

It is noted that values of spectral characteristics for which no particular incident angle is specified are measured at an incident angle of 0° (i.e., from a direction that is perpendicular to the major surface).

Dyes used in each Example are as follows.

Compounds 1-17 are UV dyes and compound 18 is an NIR dye.

Compound 1 (merocyanine compound): Synthesized by reference to Japanese Patent No. 6,504,176

Compound 2: “Nikkafluor U1” produced by Nippon Chemical Industrial Co., Ltd. was used.

Compound 3 (cyanine compound): “SMP-416” produced by Hayashibara Chemical Laboratories was used.

Compound 4 (cyanine compound): “SMP-370” produced by Hayashibara Chemical Laboratories was used.

Compound 5 (cyanine compound): “SMP-471” produced by Hayashibara Chemical Laboratories was used.

Compound 6: “Kayalight 408” produced by Nippon Kayaku Co., Ltd. was used.

Compound 7: “Kayalight B” produced by Nippon Kayaku Co., Ltd. was used.

Compound 8: “Nikkafluor MCT” produced by Nippon Chemical Industrial Co., Ltd. was used.

Compound 9 (merocyanine compound): Synthesized by reference to Japanese Patent No. 6,504,176

Compound 10 (merocyanine compound): Synthesized by reference to Japanese Patent No. 6,504,176

Compound 11 (benzoxazole compound): “UVITEX OB” produced by Tokyo Chemical Industry Co., Ltd.

Compound 12 (merocyanine compound): Synthesized by reference to Japanese Patent No. 6,504,176

Compound 13 (merocyanine compound): Synthesized by reference to Japanese Patent No. 6,504,176

Compound 14 (azo compound): Synthesized by reference to Japanese Patent No. 6,256,335

Compound 15 (merocyanine compound): Synthesized by reference to Japanese Patent No. 6,504,176

Compound 16 (triazine compound): Synthesized by reference to Japanese Patent No. 6,256,335

Compound 17 (merocyanine compound): Synthesized by reference to Japanese Patent No. 6,504,176

Compound 18 (squarylium compound); Synthesized by reference to Japanese Patent No. 6,197,940

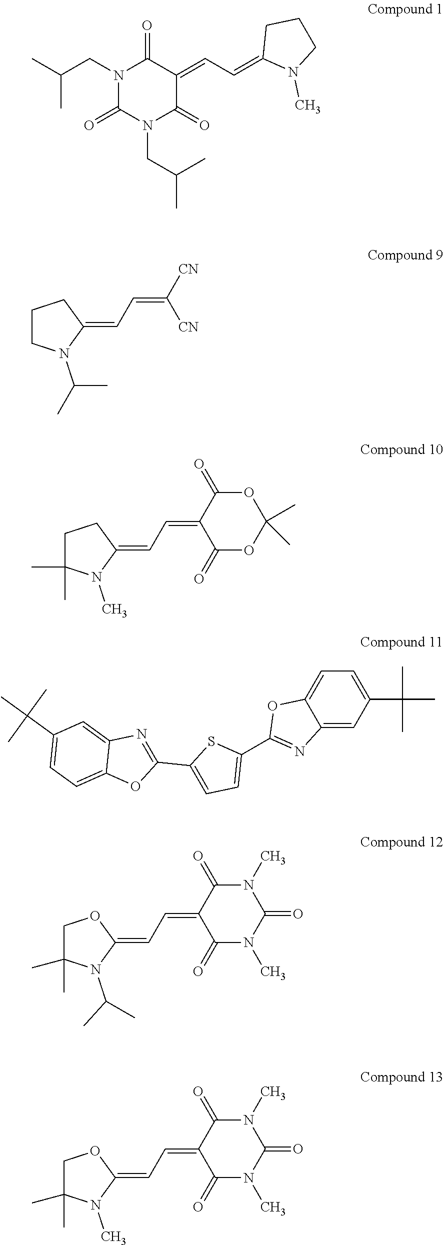

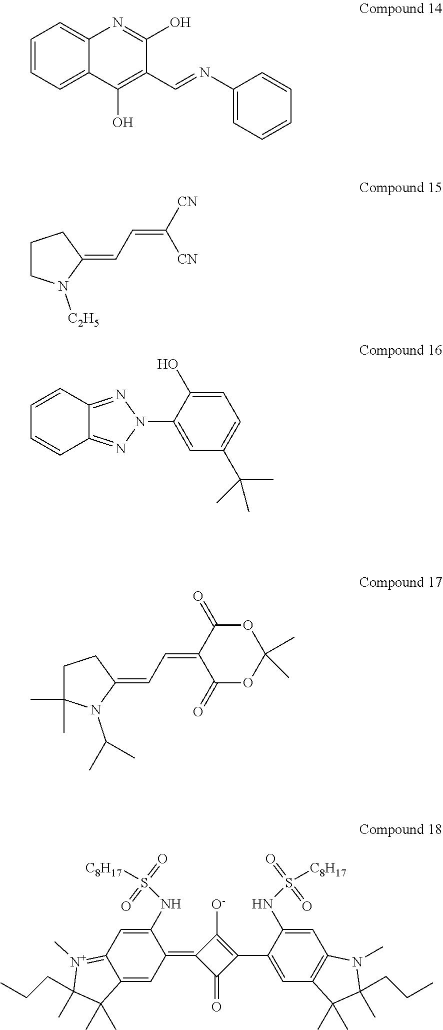

<Test A: Spectral Characteristics of UV Dye in dichloromethane>

Each dye was dissolved in dichloromethane uniformly. For each obtained solution, a maximum absorption wavelength (λₘₐₓ), and the absolute value (UV70-UV10) of the difference between a wavelength UV10 at which the transmittance was 10% and a wavelength UV70 at which the transmittance was 70% in a wavelength range of 350 to 450 nm were measured using the spectrophotometer. Results are shown in the following table.

TABLE 5

| Dye | λmax (nm) (in dichloromethane) | UV70 - UV10 (nm) |
|---|---|---|
| Compound 1 | 414 | 19 |
| Compound 2 | 362 | 43 |
| Compound 3 | 406 | 16 |
| Compound 4 | 406 | 16 |
| Compound 5 | 406 | 16 |
| Compound 6 | 366 | 48 |
| Compound 7 | 376 | 31 |
| Compound 8 | 366 | 41 |
| Compound 9 | 391 | 19 |
| Compound 10 | 379 | 19 |
| Compound 11 | 377 | 36 |
| Compound 12 | 399 | 18 |
| Compound 13 | 397 | 18 |
| Compound 14 | 376 | 34 |
| Compound 15 | 390 | 18 |
| Compound 16 | 350 | 12 |
| Compound 17 | 381 | 17 |

### <Test B: Spectral Characteristics of UV Dye in Resin>

### Example 1-1

A UV dye of compound 1 (2.5 mass %), an NIR dye of compound 18 (2.3 mass %), and a polyimide resin (polyimide varnish “C-3G30G” produced by Mitsubishi Gas Chemical Company, Inc.) diluted with an organic solvent (a mixed solvent of y-butyrolactone and cyclohexanone) were mixed together, and the dyes were dissolved sufficiently in the polyimide solution.

A resulting resin solution was applied to a glass substrate (alkali glass “D263” produced by Schott AG) by spin coating and the organic solvent was removed by sufficient heating, whereby a 5-μm-thick dye-containing polyimide thin-film was produced.

The thin-film obtained was subjected to a transmission spectral measurement at an incident direction 0° in a wavelength range of 350 to 1,200 nm using the spectrophotometer. Results are shown in the following table.

### Example 1-2 to Example 1-16

Each dye-containing resin thin-film was produced in the same manner as in Example 1-1 except that a type and an addition amount of the UV dye, an addition amount of the NIR dye and a thickness of a resin thin-film were set to a type and at values shown in the following table, and was subjected to a transmission spectral measurement.

Results are shown in the following table.

Examples 1-2, 1-5 to 1-11, 1-15, and 1-16 are Inventive Examples and Examples 1-1, 1-3, 1-4, and 1-12 to 1-14 are Comparative Examples.

T₄₄₀₋₄₈₀: Average transmittance (%) of a spectral transmittance curve in a wavelength range of 440 to 480 nm

T₄₀₀₋₄₄₀: Average transmittance (%) of the spectral transmittance curve in a wavelength range of 400 to 440 nm

T₃₇₀₋₄₀₀: Average transmittance (%) of the spectral transmittance curve in a wavelength range of 370 to 400 nm

T₄₀₀: Transmittance (%) at a wavelength of 400 nm of the spectral transmittance curve

T₃₉₀: Transmittance (%) at a wavelength of 390 nm of the spectral transmittance curve

T₃₈₀: Transmittance (%) at a wavelength of 380 nm of the spectral transmittance curve

T₃₇₀: Transmittance (%) at a wavelength of 370 nm of the spectral transmittance curve

TABLE 6

| | Ex. | Ex. | Ex. | Ex. | Ex. | Ex. | Ex. | Ex. | Ex. | Ex. | Ex. | Ex. | Ex. | Ex. | Ex. | Ex. | |
|---|---|---|---|---|---|---|---|---|---|---|---|---|---|---|---|---|---|
| | 1-1 | 1-2 | 1-3 | 1-4 | 1-5 | 1-6 | 1-7 | 1-8 | 1-9 | 1-10 | 1-11 | 1-12 | 1-13 | 1-114 | 1-15 | 1-16 | |
| UV dye compound | 1 | 2 | 3 | 4 | 5 | 6 | 7 | 8 | 9 | 10 | 11 | 12 | 12 | 13 | 10 | 9 | 10 |
| λₘₐₓ (in resin) | 414 | 362 | 406 | 406 | 394 | 366 | 373 | 373 | 391 | 379 | 377 | 399 | 399 | 397 | 379 | 391 | 379 |
| UV dye content | 2.5 | 14.3 | 3.1 | 2.5 | 3.8 | 7.3 | 5.9 | 5.8 | 4.8 | 7.8 | 5.7 | 1.4 | 0.9 | 1.4 | 1.5 | 4.5 | 7.5 |

| | | | | | | | | | | | | | | | | |
|---|---|---|---|---|---|---|---|---|---|---|---|---|---|---|---|---|
| NIR dye content | 2.3 | 1.1 | 2.3 | 2.3 | 2.3 | 2.3 | 1.1 | 1.1 | 1.1 | 1.1 | 2.3 | 2.3 | 2.3 | 2.3 | 2.3 | 2.3 |
| Resin film | 5 | 10 | 5 | 5 | 5 | 5 | 10 | 10 | 10 | 10 | 5 | 5 | 5 | 5 | 5 | 5 |
| thickness (μm) | | | | | | | | | | | | | | | | |
| (Resin film | 23.5 | 155 | 26.6 | 23.8 | 30.0 | 47.9 | 70.7 | 69.1 | 59.3 | 88.8 | 39.7 | 18.4 | 15.8 | 18.1 | 18.8 | 71.3 |
| thickness) × (NIR + | | | | | | | | | | | | | | | | |
| UV dye content) | | | | | | | | | | | | | | | | |
| (μm · mass %) | | | | | | | | | | | | | | | | |
| T₄₄₀₋₄₈₀ (%) | 82.3 | 81.6 | 83.7 | 83.9 | 84.2 | 84.2 | 83.6 | 83.3 | 84.1 | 81.4 | 84.5 | 84.3 | 84.7 | 84.3 | 84.7 | 82.8 |
| T₄₀₀₋₄₄₀ (%) | 12.7 | 45.0 | 32.3 | 31.8 | 53.9 | 43.5 | 48.5 | 48.4 | 51.3 | 56.8 | 46.7 | 42.7 | 48.0 | 47.8 | 71.0 | 54.1 |
| T [symbol] _{70-400(0deg)} (%) | 16.2 | 0.1 | 5.0 | 4.6 | 0.8 | 0.3 | 0.1 | 0.1 | 0.5 | 0.1 | 0.5 | 9.7 | 19.2 | 8.0 | 10.9 | 0.1 |
| T₄₀₀ (%) | 1.3 | 1.3 | 1.2 | 1.2 | 1.2 | 1.2 | 1.2 | 1.2 | 0.9 | 1.2 | 1.2 | 1.6 | 6.6 | 2.2 | 49.0 | 1 |
| T [symbol] ₉₀ (%) | 5.5 | 0.0 | 1.9 | 1.8 | 0.5 | 0.3 | 0.0 | 0.0 | 0.2 | 0.0 | 0.7 | 3.6 | 11.2 | 3.1 | 7.6 | 0.0 |
| T [symbol] ₈₀ (%) | 21.9 | 0.0 | 5.0 | 4.5 | 0.6 | 0.1 | 0.0 | 0.0 | 0.5 | 0.0 | 0.1 | 10.9 | 22.6 | 8.7 | 1.6 | 0.0 |
| T [symbol] ₇₀ (%) | 44.2 | 0.0 | 16.6 | 14.9 | 2.1 | 0.0 | 0.0 | 0.0 | 1.7 | 0.0 | 0.1 | 30.0 | 43.5 | 25.1 | 3.3 | 0.0 |

[symbol]

indicates data missing or illegible when filed

As is understood from the above results, Examples 1-2, 1-5 to 1-11, 1-15, and 1-16 each of which employed a UV dye(s) whose maximum absorption wavelength in dichloromethane was in a range of 360 to 395 nm showed high blue light transparency and ultraviolet light shieldability, that is, superior spectral characteristics. Example 1-16 that employed two kinds of UV dyes in combination exhibited particularly superior spectral characteristics. Although Example 1-2 showed superior spectral characteristics, to obtain desired spectral characteristics it was necessary to set the content of the UV dye and the thickness of the resin film high or large.

### Example 2-1

### Spectral Characteristics of Optical Filter

An ultraviolet/infrared-cutting multilayer film having a passband in a range of 400 to 700 nm was formed on a glass substrate (alkali glass “D263” produced by Schott AG). The same resin thin-film (absorption film) as employed in Example 1-1 was formed on the multilayer film by spin coating. Subsequently, a dielectric multilayer film (anti-reflection film) made of SiO₂ and TiO₂ was formed on the resin thin-film by vapor deposition, whereby an absorption infrared cutting filter was produced. The produced infrared cutting filter was subjected to a transmission spectral measurement at incident directions 0° and 50° in a wavelength range of 350 to 1,200 nm using the spectrophotometer. Results are shown in the following table.

### Example 2-2 to 2-15

Each infrared cutting filter was produced by the same method as in Example 2-1 except that a type and an addition amount of the UV dye, an addition amount of the NIR dye, and a thickness of the resin thin-film were set to a type and at values shown in the following table, and subjected to a transmission spectral measurement.

Results are shown in the following table.

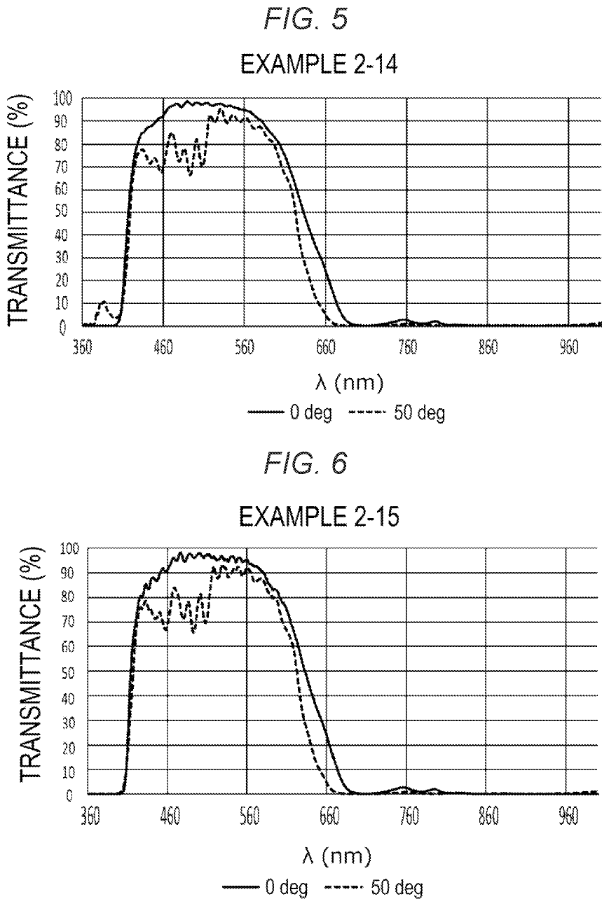

Furthermore, spectral transmittance curves of the infrared cutting filters of Examples 2-14 and 2-15 are shown in FIGS. 5 and 6, respectively. The solid-line curve is a spectral transmittance curve obtained at an incident direction 0° and the broken-line curve is a spectral transmittance curve obtained at an incident direction 50°.

Examples 2-5, 2-6, 2-9, 2-10, and 2-15 are Inventive Examples and Examples 2-1 to 2-4, 2-7, 2-8, and 2-11 to 2-14 are Comparative Examples.

λₘₐₓ: Maximum absorption wavelength (nm)

T₄₄₀₋₄₈₀: Average transmittance (%) of a spectral transmittance curve in a wavelength range of 440 to 480 nm

T₄₀₀₋₄₄₀: Average transmittance (%) of a spectral transmittance curve in a wavelength range of 400 to 440 nm

T_{370-400(odeg)}: Average transmittance (%) of a spectral transmittance curve at an incident angle of 0° in a wavelength range of 370 to 400 nm

T_{370-400(50deg)}: Average transmittance (%) of a spectral transmittance curve at an incident angle of 50° in a wavelength range of 370 to 400 nm

UV10_{(0deg)}: Wavelength (nm) at which the transmittance was 10% at an incident angle of 0° in a wavelength range of 350 to 450 nm

UV10_{(50deg)}: Wavelength (nm) at which the transmittance was 10% at an incident angle of 50° in a wavelength range of 350 to 450 nm

UV20_{(0deg)}: Wavelength (nm) at which the transmittance was 20% at an incident angle of 0° in a wavelength range of 350 to 450 nm

UV20_{(50deg)}: Wavelength (nm) at which the transmittance was 20% at an incident angle of 50° in a wavelength range of 350 to 450 nm

UV50_{(0deg)}: Wavelength (nm) at which the transmittance was 50% at an incident angle of 0° in a wavelength range of 350 to 450 nm

UV50_{(50deg)}: Wavelength (nm) at which the transmittance was 50% at an incident angle of 50° in a wavelength range of 350 to 450 nm

UV70_{(0deg)}: Wavelength (nm) at which the transmittance was 70% at an incident angle of 0° in a wavelength range of 350 to 450 nm

|UV70_{(0deg)}-UV10_{(0deg)}|: Absolute value (nm) of the difference between UV10_{(0deg)} and UV70_{(0deg)}

|UV10_{(50deg)}-UV10_{(0deg)}|: Absolute value (nm) of the difference between UV10_{(0deg)} and UV10_{(50deg)}

|UV20_{(50deg)}-UV20_{(0deg)}|: Absolute value (nm) of the difference between UV20_{(0deg)} and UV20_{(50deg)}

|UV50_{(50deg)}-UV50_{(0deg)}|: Absolute value (nm) of the difference between UV50_{(0deg)} and UV50_{(50deg)}

TABLE 7

| | Ex. | Ex. | Ex. | Ex. | Ex. | Ex. | Ex. | Ex. |
|---|---|---|---|---|---|---|---|---|
| | 2-1 | 2-2 | 2-3 | 2-4 | 2-5 | 2-6 | 2-7 | 2-8 |
| UV dye compound | 1 | 2 | 3 | 4 | 5 | 6 | 7 | 8 |
| UV dye content | 2.5 | 14.3 | 3.1 | 2.5 | 3.8 | 7.3 | 5.9 | 5.8 |
| NIR dye content | 2.3 | 1.1 | 2.3 | 2.3 | 2.3 | 2.3 | 1.1 | 1.1 |
| Resin film | 5.0 | 10.0 | 5.0 | 5.0 | 5.0 | 5.0 | 10.0 | 10.0 |
| thickness (μm) | | | | | | | | |
| (Resin film | 23.5 | 154.7 | 26.6 | 23.8 | 30.0 | 47.9 | 70.7 | 69.1 |
| thickness) × (NIR + | | | | | | | | |
| UV dye content) | | | | | | | | |
| (μm · mass %) | | | | | | | | |
| λ_{(max)DIC} (nm) | 414 | 362 | 406 | 406 | 394 | 366 | 373 | 373 |
| T₄₄₀₋₄₈₀ (%) | 90.3 | 89.5 | 92.0 | 92.0 | 92.3 | 92.3 | 91.7 | 91.5 |
| T₄ [symbol] ₀- [symbol] (%) | 13.7 | 47.9 | 35.2 | 34.8 | 56.9 | 47.1 | 51.6 | 51.5 |
| T_{370-400(0deg)} (%) | 0.05 | 0.00 | 0.02 | 0.02 | 0.00 | 0.00 | 0.00 | 0.00 |
| T_{370-400(50deg)} (%) | 3.5 | 0.0 | 0.8 | 0.8 | 0.2 | 0.1 | 0.0 | 0.0 |
| UV10_{(0deg)} (nm) | 427.9 | 406.3 | 415.4 | 415.5 | 407.3 | 410.6 | 406.8 | 407.5 |
| UV20_{(0deg)} (nm) | 430.2 | 410.8 | 418.2 | 418.6 | 409.2 | 413.3 | 410.3 | 410.4 |
| UV50_{(0deg)} (nm) | 435.4 | 417.4 | 424.1 | 424.3 | 412.6 | 418.7 | 415.7 | 415.7 |
| UV70_{(0deg)} (nm) | 439.6 | 426.3 | 430.2 | 430.4 | 417.7 | 423.5 | 422.4 | 422.5 |
| UV70_{(0deg)} − | 11.7 | 20.0 | 14.8 | 14.8 | 10.4 | 12.9 | 15.6 | 15.0 |
| UV10_{(0deg)}\| (nm) | | | | | | | | |
| UV10_{(50deg)} − | 1.1 | 4.4 | 0.5 | 0.7 | 0.1 | 2.4 | 3.9 | 3.7 |
| UV10_{(0deg)}\| (nm) | | | | | | | | |
| UV20_{(50deg)} − | 0.6 | 1.8 | 1.3 | 1.1 | 0.5 | 1.9 | 1.4 | 1.4 |
| UV20_{(0deg)}\| (nm) | | | | | | | | |
| UV50₍ [symbol] _{0deg)} − | 1.7 | 2.4 | 1.4 | 1.4 | 3.6 | 1.4 | 2.8 | 2.9 |
| UV50_{(0deg)}\| (nm) | | | | | | | | |
| | Ex. | Ex. | Ex. | Ex. | Ex. | Ex. | Ex. | |
| | 2-9 | 2-10 | 2-11 | 2-12 | 2-13 | 2-14 | 2-15 | |
| UV dye compound | 9 | 10 | 11 | 12 | 12 | 13 | 9 | 10 |
| UV dye content | 4.8 | 7.8 | 5.7 | 1.4 | 0.9 | 1.4 | 4.5 | 7.5 |

| | | | | | | | |
|---|---|---|---|---|---|---|---|
| NIR dye content | 1.1 | 1.1 | 2.3 | 2.3 | 2.25 | 2.3 | 2.25 |
| Resin film | 10.0 | 10.0 | 5.0 | 5.0 | 5 | 5.0 | 5 |
| thickness (μm) | | | | | | | |
| (Resin film | 59.3 | 88.8 | 39.7 | 18.4 | 15.8 | 18.1 | 71.3 |
| thickness) × (NIR + | | | | | | | |
| UV dye content) | | | | | | | |
| (μm · mass %) | | | | | | | |

| | | | | | | | | |
|---|---|---|---|---|---|---|---|---|
| λ_{(max)DIC} (nm) | 391 | 379 | 377 | 399 | 399 | 397 | 379 | 391 |

| | | | | | | | |
|---|---|---|---|---|---|---|---|
| T₄₄₀₋₄₈₀ (%) | 92.2 | 89.3 | 92.7 | 92.5 | 92.74 | 92.5 | 90.8 |
| T₄ [symbol] ₀- [symbol] (%) | 54.5 | 58.5 | 50.4 | 46.2 | 50.60 | 51.1 | 56.6 |
| T_{370-400(0deg)} (%) | 0.00 | 0.00 | 0.00 | 0.04 | 0.07 | 0.03 | 0.0 |
| T_{370-400(50deg)} (%) | 0.1 | 0.0 | 0.2 | 1.9 | 5.5 | 1.5 | 0.0 |
| UV10_{(0deg)} (nm) | 407.3 | 405.8 | 409.3 | 411.1 | 408.1 | 407.2 | 407.1 |
| UV20_{(0deg)} (nm) | 409.8 | 408.1 | 411.9 | 413.4 | 411.1 | 411.0 | 408.8 |
| UV50_{(0deg)} (nm) | 413.9 | 411.2 | 416.6 | 419.1 | 417.0 | 416.2 | 407.1 |
| UV70_{(0deg)} (nm) | 420.1 | 415.4 | 421.5 | 424.1 | 422.5 | 421.7 | 418.1 |
| UV70_{(0deg)} − | 12.8 | 9.5 | 12.2 | 13.0 | 16.6 | 14.5 | 11.0 |
| UV10_{(0deg)}\| (nm) | | | | | | | |
| UV10_{(50deg)} − | 1.9 | 1.2 | 3.2 | 2.3 | 4.2 | 4.9 | 1.6 |
| UV10_{(0deg)}\| (nm) | | | | | | | |
| UV20_{(50deg)} − | 0.9 | 0.3 | 1.6 | 2.0 | 1.8 | 1.5 | 0.3 |
| UV20_{(0deg)}\| (nm) | | | | | | | |
| UV50₍ [symbol] _{0deg)} − | 3.3 | 3.4 | 2.0 | 1.3 | 2.1 | 2.4 | 1.6 |
| UV50_{(0deg)}\| (nm) | | | | | | | |

[symbol]

indicates data missing or illegible when filed

As is understood from the above results, the optical filters of Examples 2-5, 2-6,2-9, 2-10, and 2-15 each of which employed a UV dye in which the maximum absorption wavelength in dichloromethane was in a range of 360 to 395 nm and the spectral characteristics in a solution (UV70-UV10) in test A and the spectral characteristics in a resin in test B were in the prescribed ranges were high in blue light transparency and were high in the ultraviolet light shieldability even at large incident angles, that is, showed superior spectral characteristics. The optical filter of Example 2-15 that employed the two kinds of UV dyes in combination exhibited particularly superior spectral characteristics.

On the other hand, the optical filters of Examples 2-1, 2-3, 2-4, 2-12, 2-13, and 2-14 in each of which the maximum absorption wavelength was not in the prescribed range, and the optical filters of Examples 2-2, 2-7, 2-8, and 2-11 in each of which the spectral characteristics in a solution in test A were not in the prescribed ranges were low in blue light transparency or the ultraviolet light shieldability at large incident angles.

### Example 3-1

### Evaluation of Light Resistance

A UV dye of compound 1 (7.5 mass %), a UV dye of compound 13 (3.5 mass %), an NIR dye of compound 18 (7 mass %), and a polyimide resin (polyimide varnish “C-3G30G” produced by Mitsubishi Gas Chemical Company, Inc.) diluted with an organic solvent (a mixed solvent of γ-butyrolactone and cyclohexanone) were mixed together, and the dyes were dissolved sufficiently in the polyimide solution. The addition amounts of the dyes are addition amounts with respect to the resin.

A resulting solution was applied to a glass substrate (alkali glass “D263” produced by Schott A G) by spin coating and the organic solvent was removed by sufficient heating, whereby a 1.5-μm-thick dye-containing polyimide film was produced.

The same anti-reflection film as employed in in Example 2-1 was formed on the produced polyimide film by vapor deposition. An optical sample obtained was subjected to a light resistance test using a super xenon weather meter produced by Suga Test Instruments Co., Ltd. The light incident surface was the anti-reflection film surface.

A light quantity was set so as to become 80,000 J/mm² as an accumulated light quantity in a wavelength range of 300 to 2,450 nm. NIR dye survival rates were calculated on the basis of absorption coefficients at 400 nm and 680 nm obtained before and after the sample was subjected to the light resistance test. Results are shown in the following table.

The light resistance was judged high if the survival rate at 400 nm (T400-nm survival rate) was 85% or more and the survival rate at 680 nm (T680-nm survival rate) was 75% or more.

### Examples 3-2 to 3-10

### Evaluation of Light Resistance

Each light resistance test was performed in the same manner as in Example 3-1 except that the dye types and their contents were set to types and at values shown in the following table.

Results are shown in the following table.

Examples 3-1 to 3-4, 3-5, and 3-7 to 3-10 are Inventive Examples and Example 3-6 is a Comparative Example.

TABLE 8

| | | | | | | | | | | | AR surface | |
|---|---|---|---|---|---|---|---|---|---|---|---|---|
| | | | | | | | | | | | irradiation | |
| | | | | | | | | | | | T400 | T680 |
| | | NIR dye | | | UV dye 1 | | | UV dye 2 | | | survival | survival |
| | | Com- | | Content | Com- | | Content | Com- | | Content | rate | rate |
| | Resin | pound | Structure | (mass %) | pound | Structure | (mass %) | pound | Structure | (mass %) | (%) | (%) |
| Ex. | Polyimide | 18 | Squarylium | 7 | 1 | Merocyanine | 7.5 | 13 | Merocyanine | 3.5 | 97.1 | 84 |
| 3-1 | | | | | | | | | | | | |
| Ex. | Polyimide | 18 | Squarylium | 7 | 13 | Merocyanine | 7.5 | 10 | Merocyanine | 4.5 | 98.7 | 94.4 |
| 3-2 | | | | | | | | | | | | |
| Ex. | Polyimide | 18 | Squarylium | 7 | 10 | Merocyanine | 9 | 9 | Merocyanine | 4.5 | 87.4 | 79.7 |
| 3-3 | | | | | | | | | | | | |
| Ex. | Polyimide | 18 | Squarylium | 7 | 1 | Merocyanine | 7.5 | — | — | — | 96.2 | 76.2 |
| 3-4 | | | | | | | | | | | | |
| Ex. | Polyimide | 18 | Squarylium | 7 | 10 | Merocyanine | 9 | — | — | — | 84 | 79.9 |
| 3-5 | | | | | | | | | | | | |
| Ex. | Polyimide | 18 | Squarylium | 7 | — | — | — | — | — | — | 100 | 92.1 |
| 3-6 | | | | | | | | | | | | |
| Ex. | Polyimide | 18 | Squarylium | 7 | 13 | Mcrocyanine | 5 | 11 | Benzoxazole | 7.5 | 94.6 | 73.5 |
| 3-7 | | | | | | | | | | | | |
| Ex. | Polyimide | 18 | Squarylium | 7 | 10 | Merocyanine | 5 | 11 | Benzoxazole | 7.5 | 94.5 | 68.2 |
| 3-8 | | | | | | | | | | | | |
| Ex. | Polyimide | 18 | Squarylium | 7 | 5 | Unknown | 5 | 11 | Benzoxazole | 7.5 | 92.5 | 54.9 |
| 3-9 | | | | | | | | | | | | |
| Ex. | Polyimide | 18 | Squarylium | 7 | 4 | Unknown | 5 | 11 | Benzoxazole | 7.5 | 88.7 | 66 |
| 3-10 | | | | | | | | | | | | |

A tendency is found from the above results (i.e., comparison between Example 3-6 and Examples 3-4 and 3-5) that coexistence of a UV dye and an NIR dye results in degradation of the NIR dye. As seen from Examples 3-1 to 3-3, using plural merocyanine compounds in combination as UV dyes can suppress degradation of an NW dye.

Although the present invention has been described above in detail with reference to the particular embodiment, it is apparent to those skilled in the art that various changes and modifications can be made without departing from the spirit and scope of the present invention. The present application is based on Japanese Patent Application No. 2020-126700 filed on Jul. 27, 2020, the disclosure of which is incorporated herein by reference.

### INDUSTRIAL APPLICABILITY

The optical filter according to the present invention exhibits an excellent ultraviolet light shieldability property in which, in particular, the reduction of ultraviolet light shieldability at large incident angles is suppressed while the near-infrared light shieldability and the visible light transparency, in particular, the blue light transparency, is kept high. The optical filter according to the present invention is useful when used in, for example, information acquisition devices such as cameras and sensors for transport machines that have been being increased in performance in recent years.

### DESCRIPTION OF SYMBOLS

1A, 1B, 1C, 1D . . . Optical filter; 10 . . . Substrate; 11 . . . Support body; 12 . . . Resin film; 30 . . . Dielectric multilayer film.

1. An optical filter comprising:
a substrate; and
a dielectric multilayer film laid on or above at least one major surface of the substrate, as an outermost layer, wherein:
the substrate comprises a resin film containing a dye (U) having a maximum absorption wavelength in a range of 360 to 395 nm in dichloromethane, a dye (A) having a maximum absorption wavelength in a range of 600 to 800 nm in dichloromethane, and a resin; and
the optical filter satisfies all of the following spectral characteristics (i-1) to (i-5):
(i-1) an average transmittance T₄₄₀₋₄₈₀ of a spectral transmittance curve in a wavelength range of 440 to 480 nm is 86% or more;
(i-2) an absolute value of a difference between UV10_{(0deg)} and UV10_{(50deg)} is 3 nm or less, an absolute value of a difference between UV20_{(0deg)} and UV20_{(50deg)} is 4 nm or less, and an absolute value of a difference between UV50_{(0deg)} and UV50_{(50deg)} is 3 nm or less, where UV10_{(0deg)}, UV20_{(0deg)}, and UV50_{(0deg)} represent wavelengths at which transmittances are 10%, 20%, and 50%, respectively, at an incident angle of 0° in a wavelength range of 350 to 450 nm, and UV10_{(50deg)}, UV20_{(50deg)}, and UV50_{(50deg)} represent wavelengths at which transmittances are 10%, 20%, and 50%, respectively, at an incident angle of 50° in a wavelength range of 350 to 450 nm;
(i-3) an average transmittance T₄₀₀₋₄₄₀ of a spectral transmittance curve in a wavelength range of 400 to 440 nm is 40% or more;
(i-4) an average transmittance T_{370-400(0deg)} of a spectral transmittance curve at an incident angle of 0° in a wavelength range of 370 to 400 nm is 1% or less; and
(i-5) an average transmittance T_{370-400(50deg)} of a spectral transmittance curve at an incident angle of 50° in a wavelength range of 370 to 400 nm is 0.5% or less.

2. The optical filter according to claim 1, wherein the optical filter further satisfies the following spectral characteristic (i-6):
(i-6) an absolute value of a difference between UV10_{(0deg)} and UV70_{(0deg)} is 16 nm or less, where UV10_{(0deg)} and UV70_{(0deg)} represent wavelengths at which transmittances are 10% and 70%, respectively, at an incident angle of 0° in a wavelength range of 350 to 450 nm.

3. The optical filter according to claim 1, wherein the dye (U), in a spectral transmittance curve of a coated film formed by coating an alkali glass plate with a solution obtained by dissolving the dye (U) in the resin, satisfies all of the following spectral characteristics (ii-1) to (ii-6):
(ii-1) an average transmittance T₄₀₀₋₄₄₀ in a wavelength range of 400 to 440 nm is 40% or more;
(ii-2) an average transmittance T₃₇₀₋₄₀₀ in a wavelength range of 370 to 400 nm is 5% or less;
(ii-3) a transmittance T₄₀₀ at a wavelength of 400 nm is 7% or less;
(ii-4) a transmittance T₃₉₀ at a wavelength of 390 nm is 5% or less;
(ii-5) a transmittance T₃₈₀ at a wavelength of 380 nm is 5% or less; and
(ii-6) a transmittance T₃₇₀ at a wavelength of 370 nm is 5% or less.

4. The optical filter according to claim 1, wherein the dye (U) further satisfies the following spectral characteristic (iii-1):
(iii-1) an absolute value of a difference between UV10 and UV70 is 25 nm or less, where UV10 and UV70 represent wavelengths at which transmittances are 10% and 70%, respectively, in a wavelength range of 350 to 450 nm in a spectral transmittance curve that is measured by dissolving the dye (U) in dichloromethane so that a transmittance at a maximum absorption wavelength becomes 10%.

5. The optical filter according to claim 1, wherein the resin film has a thickness of 10 μm or less, and a product of a total content of the dye (U) and the dye (A) in the resin film and the thickness of the resin film is 100 (mass %·μm) or less.

6. The optical filter according to claim 1, wherein:
the dye (U) is a dye (U1) having a maximum absorption wavelength in a range of 370 to 385 nm in dichloromethane;
the resin film further comprises a dye (U2) having a maximum absorption wavelength in a range of 385 to 405 nm in dichloromethane; and
an absolute value of a difference between maximum absorption wavelengths of the dye (U1) and the dye (U2) in the resin is 10 nm or more and 15 nm or less.

7. The optical filter according to claim 1, wherein the optical filter further satisfies all of the following spectral characteristics (i-4-1) to (i-6-1):
(i-4-1) the average transmittance T_{370-400(0deg)} is 0.5% or less;
(i-5-1) the average transmittance T_{370-400(50deg)} is 0.1% or less; and
(i-6-1) an absolute value of a difference between UV10_{(0deg)} and UV10_{(70deg)} is 14 nm or less, where UV10_{(0deg)} and UV70_{(0deg)} represent wavelengths at which transmittances are 10% and 70%, respectively, at an incident angle of 0° in a wavelength range of 350 to 450 nm.

8. The optical filter according to claim 1, wherein the dye (U) comprises a merocyanine dye.

9. The optical filter according to claim 8, wherein the merocyanine dye is a compound represented by the following Formula (M): 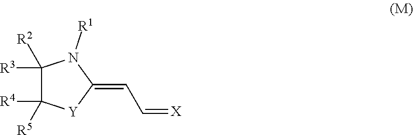
where symbols in Formula (M) have the following meanings:
R¹ represents a monovalent hydrocarbon group having a carbon number of 1 to 12 that may include a substituent;
R² to R⁵ represent, independently of each other, a hydrogen atom, a halogen atom, an alkyl group having a carbon number of 1 to 10, or an alkoxy group having a carbon number of 1 to 10;
Y represents an oxygen atom or a methylene group that is replaced by R⁶ and R⁷;
R⁶ and R⁷ represent, independently of each other, a hydrogen atom, a halogen atom, an alkyl group having a carbon number of 1 to 10, or an alkoxy group having a carbon number of 1 to 10; and
X represents one of divalent groups represented by the following Formulae (X1) to (X5), where R⁸ and R⁹ represent, independently of each other, a monovalent hydrocarbon group having a carbon number of 1 to 12 that may include a substituent, and R¹⁰ to R¹⁹ represent, independently of each other, a hydrogen atom or a monovalent hydrocarbon group having a carbon number of 1 to 12 that may include a substituent:

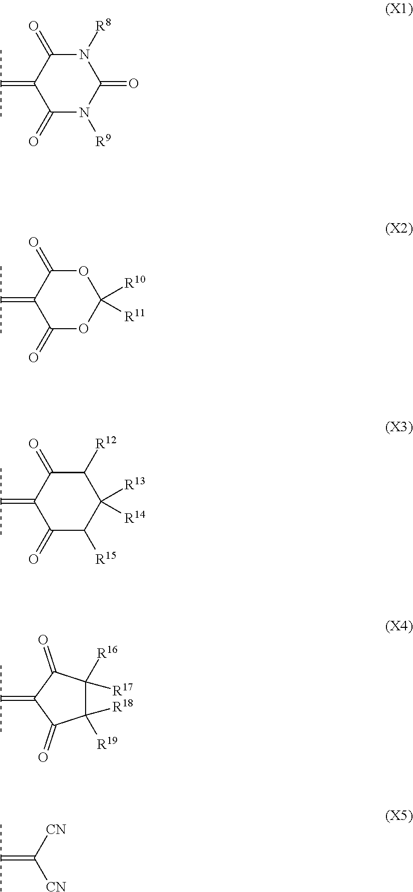

10. The optical filter according to claim 1, wherein the dye (A) comprises at least one dye selected from a squarylium dye, a phthalocyanine dye, and a cyanine dye.

11. The optical filter according to claim 1, wherein the dye (A) comprises a squarylium dye that is made of a compound represented by the following Formula (I): 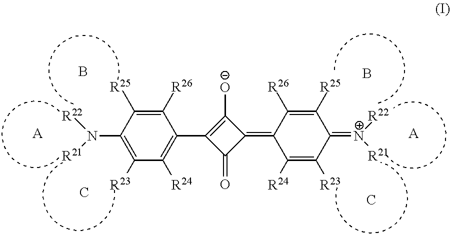
where symbols in Formula (I) have the following meanings:
R²⁴ and R²⁶ represent, independently of each other, a hydrogen atom, a halogen atom, an hydroxyl group, an alkyl group having a carbon number of 1 to 6, an alkoxy group having a carbon number of 1 to 6, an acyloxy group having a carbon number of 1 to 10, —NR²⁷R²⁸ (R²⁷ and R²⁸ represent, independently of each other, a hydrogen atom, an alkyl group having a carbon number of 1 to 20, —C(═O)—R²⁹ (R²⁹ represents a hydrogen atom, an alkyl group having a carbon number 1 to 20 that may include a substituent, an aryl group having a carbon number of 6 to 11 that may include a substituent, or an alaryl group having a carbon number of 7 to 18 that may include a substituent and may have an oxygen atom between carbon atoms), —NHR³⁰ or SO₂—R³⁰ (each R³⁰ represents a hydrocarbon group having a carbon number of 1 to 25 whose one or more hydrogen atoms may be replaced by a halogen atom, an hydroxy group, a carboxy group, a sulfo group, or a cyano group and that may include an unsaturated bond, an oxygen atom, or a saturated or unsaturated ring structure between carbon atoms), or a group represented by the following Formula (S) (R⁴¹ and R⁴² represent, independently of each other, a hydrogen atom, a halogen atom, an alkyl group having a carbon number of 1 to 10, or an alkoxy group having a carbon number of 1 to 10, and k represents 2 or 3); 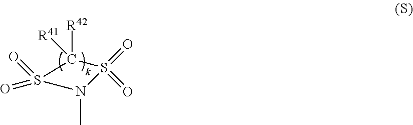
R²¹ and R²², R²² and R²⁵, and R²¹ and R²³ may form a heterocycle A, a heterocycle B, and a heterocycle C each having five or six members, respectively, together with a nitrogen atom by connecting to each other in which:
R²¹ and R²² form, in the case where the heterocycle A is formed, as a divalent group -Q- as a result of their connection, an alkylene group or an alkyleneoxy group whose hydrogen atom may be replaced by an alkyl group having a carbon number of 1 to 6, an aryl group having a carbon number of 6 to 10, or an acyloxy group having a carbon number of 1 to 10 that may include a substituent, and
R²² and R²⁵ form, in the case where the heterocycle B is formed, as a result of their connection, and R²¹ and R²³ form, in the case where the heterocycle C is formed, as a result of their connection, divalent groups —X¹—Y¹— and —X²—Y²— (X¹ and X² connect the nitrogen) , respectively, and each of X¹ and X² is represented by the following Formula (1x) or (2x) and each of Y¹ and Y² is represented by one of the following Formulae (1y) to (5y), and in the case where each of X¹ and X² is a group represented by the following Formula (2x), each of Y¹ and Y² may be a single bond in which case an oxygen atom may exist between carbon atoms 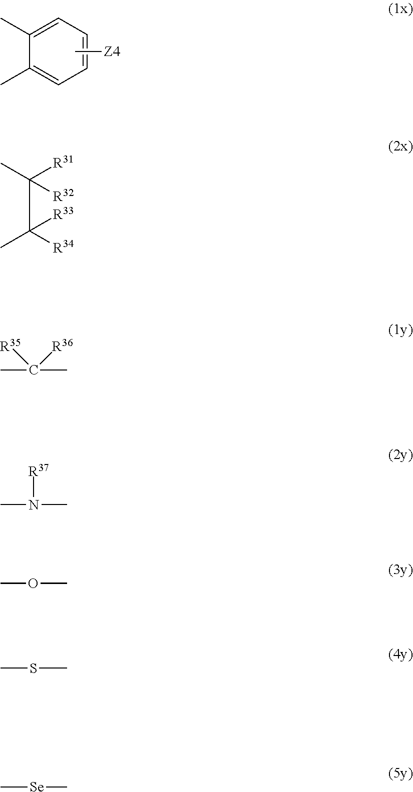
in which four Zs in Formula (1x) represent, independently of each other, a hydrogen atom, an hydroxy group, an alkyl group having a carbon number of 1 to 6, an alkoxy group having a carbon number of 1 to 6, or —NR³⁸R³⁹ (R³⁸ and R³⁹ represent, independently of each other, a hydrogen atom or an alkyl group having a carbon number of 1 to 20), R³¹ to R³⁶ represent, independently of each other, a hydrogen atom, an alkyl group having a carbon number of 1 to 6, or an aryl group having a carbon number of 6 to 10, and R³⁷ represents an alkyl group having a carbon number of 1 to 6 or an aryl group having a carbon number of 6 to 10;
R²⁷, R²⁸, R²⁹, R³¹ to R³⁷, R²¹ to R²³ not forming a heterocycle, and R²⁵ may form a 5-membered ring or a 6-membered ring by connecting to one of the others, and R³¹ and R³⁶ or R³¹ and R³⁷ may connect to each other directly; and
R²¹ and R²² not forming a heterocycle represent, independently of each other, a hydrogen atom, an alkyl group having a carbon number of 1 to 6 and that may include a substituent, an allyl group that may include a substituent, an aryl group having a carbon number of 6 to 11 and that may include a substituent, or an alaryl group having a carbon number of 6 to 11 and that may include a substituent, and R²³ and R²⁵ not forming a heterocycle represent, independently of each other, a hydrogen atom, a halogen atom, an alkyl group having a carbon number of 1 to 6, or an alkoxy group having a carbon number of 1 to 6.

12. The optical filter according to claim 1, wherein the resin is a transparent resin.

13. The optical filter according to claim 12, wherein the transparent resin comprises a polyimide resin.
